(19) United States
(12) Patent Application Publication
(10) Pub. No.: US 2015/0230462 A1
(43) Pub. Date: Aug. 20, 2015

(54) METHODS FOR IMPROVING GERMINATION AND STRESS TOLERANCE CHARACTERISTICS WITH JASMONATES

(71) Applicant: New Biology, Inc., Burlingame, CA (US)

(72) Inventors: Barbara Scheer, Burlingame, CA (US); Justin Scheer, Burlingame, CA (US)

(21) Appl. No.: 14/597,529

(22) Filed: Jan. 15, 2015

Related U.S. Application Data
(60) Provisional application No. 61/927,867, filed on Jan. 15, 2014.
(60) Provisional application No. 61/973,122, filed on Mar. 31, 2014.

(51) Int. Cl. A01N 37/42; A01N 25/02; A01C 1/06

(52) U.S. Cl. CPC A01N 37/42; A01C 1/06; A01N 25/02

(57) ABSTRACT

Methods of seed treatment with one or more jasmonates are described. One method comprises exposing a seed to a formulation containing methyl dihydrojasmonate (MDHJ) at an amount and duration effective for improving a germination characteristic of the seed. Another method comprises exposing a seed to a formulation containing MDHJ at an amount and duration effective for improving a stress tolerance characteristic of the seed. Seeds comprising an effective amount of MDHJ for improving a germination or stress tolerance characteristic are also described.

### CROSS-REFERENCE TO RELATED APPLICATIONS

The present application relies on and claims priority to and the benefit of the filing date of U.S. Provisional Application No. 61/927,867 filed on Jan. 15, 2014, the disclosure of which is hereby incorporated by reference in its entirety.

### BACKGROUND OF THE INVENTION

1. Field of the Invention

Generally speaking, the invention relates to the fields of agriculture and plant biology, and more specifically, to methods for improving seed germination and/or stress tolerance with jasmonates, such as methyl dihydrojasmonate.

2. Description of Related Art

The jasmonates are a family of compounds related to jasmonic acid, 2-(3-oxo-2-(pent-2-enyl)cyclopentyl)acetic acid, the structure of which is shown below in Formula (1):

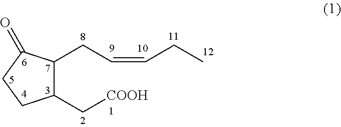

Jasmonates have been implicated in regulating a number of events in plant growth and development, as well as numerous types of plant responses to stressors. Osmotic stress or desiccation, touch, elicitation, wounding, and pathogen and insect attack are all generally accompanied by increases in endogenous levels of jasmonates. Jasmonates are also widely used as flavoring and fragrance compounds because of their strong odor and taste characteristics.

Plants mount defenses to abiotic and biotic stressors by sensing a stress and responding with changes in signaling pathways that elicit the production of protective factors. Plants can use multiple signaling pathways in response to a stress, and they may be unique to a particular stress condition or used in response to multiple stress conditions. For example, the signaling molecule jasmonic acid is involved in responses to an array of biotic and abiotic stressors, and the 18 amino acid polypeptide hormone systemin has been shown in induce a number of defense genes in tomato and other members of the Solanaceae family. In contrast, transcriptome profiling studies have shown that plants subjected to different abiotic stress conditions including heat, drought, salt, light, cold, or mechanical stress had somewhat unique responses with little overlap in transcript expression between conditions. Drought stress in particular has been shown to rely on the interaction of multiple defense genes.

Of the jasmonate compounds, the most widely studied are methyl jasmonate and jasmonic acid itself. However, the present inventors have studied the efficacy of 9, 10-dihydromethyl jasmonate, also called methyl dihydrojasmonate (MDHJ), for various purposes. The general structure of MDHJ is given below in Formula (2):

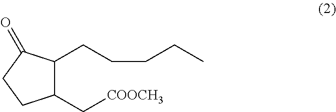 [SMILES: CCCCCC1C(=O)CCC1CC(=O)OC]

The work of the present inventors has shown, for example, that MDHJ is surprisingly effective at preventing biotic attack, as described in U.S. Patent Application Publication No. 2009/0082453; that MDHJ improves flowering characteristics, as described in U.S. Patent Application Publication No. 2009/0133166; and that MDHJ can reduce the chlorosis and necrosis of leaf senescence, as described in U.S. Pat. Nos. 8,013,226 and 8,563,839. All of these references are incorporated by reference in their entireties.

The effects of jasmonic acid and/or the jasmonates on seeds have not been extensively studied. A few references, like U.S. Pat. No. 8,115,053 to Roberts et al., demonstrate that treating non-germinated seeds with jasmonic acid or methyl jasmonate increases pest resistance in the resulting plants up to 10 weeks after sowing. While Roberts et al. and a few similar references may show that established plants derive benefit from jasmonate application prior to seed germination, little is known about their effects on seed germination itself, and at least one study has shown that methyl jasmonate inhibits seed germination (Norastehnia et al., Gen. Appl. Plant Physiology, 2007, 33 (1-2), pp. 13-23, the contents of which are incorporated by reference in their entirety). Roberts et al. also notes that the application of jasmonates delayed germination of the seeds.

### SUMMARY OF THE INVENTION

One aspect of the invention relates to methods for improving the germination characteristics or stress tolerance characteristics of the seeds of a plant. In one embodiment, the invention provides a method of seed treatment comprising exposing a seed to a formulation containing one or more jasmonates, such as MDHJ, at an amount and duration effective for improving a germination characteristic of the seed. In another embodiment, the invention provides a method of seed treatment comprising exposing a seed to a formulation containing one or more jasmonates, such as MDHJ, at an amount and duration effective for improving a stress tolerance characteristic of the seed. The methods comprise soaking the seeds in a liquid medium comprising one or more jasmonates or exposing them to a solid preparation comprising one or more jasmonates for a predefined amount of time. The seeds may be dormant seeds, non-germinating seeds, or germinating seeds.

As used herein, the term one or more jasmonates refers to and includes any one or more of jasmonic acid, derivatives of jasmonic acid, or salts of jasmonic acid, especially those with stress tolerance or germination promoting activity. Non-limiting examples of jasmonates include jasmonic acid, methyl dihydrojasmonate, n-propyl dihydrojasmonate, methyl jasmonate, potassium jasmonate, sodium jasmonate, jasmonic acid methyl ester, cis-jasmone, natural jasmonates, synthetic jasmonates, jasmonate derivatives, salts of jasmonate derivatives, and the like, and the salts of the like, especially compounds of Formula (3) below:

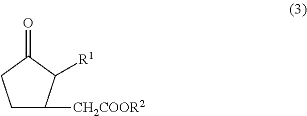

wherein R¹ is pentyl or pentenyl and R² is hydrogen or a C₁-C₁₀ alkyl group. Especially preferred are jasmonates recited in U.S. Pat. Nos. 5,776,860; 5,814,581; 6,093,683; 6,271,176; 6,890,525; 7,820,153; 8,115,053; 8,329,617; and 8,507,756, and International Patent Application No. WO 2013/165477, as well as in U.S. Published Application Nos. 2005/0049230 and 2012/0077674, and in JP Patent No. 2002-047104, and in Differential Effect of Jasmonic Acid on the Defense of Faba Bean Against Fusarium Wilt: Changes in Protein and DNA Patterns, Peroxidase and Esterase Isozymes, Magda M. El-Araby and Hala F. S. Ahmed, Int. J. Agri. Biol., Vol. 6, No. 2, 2004, 226-232, each reference of which is hereby incorporated by reference herein in its entirety.

The methods may also include planting the seeds after treatment, or continuing treatment during and/or after planting the seeds. Treatment during and/or after planting may be continued by applying one or more jasmonates, such as in an extended-release formulation, to the seeds, or treating the soil surrounding the planted seeds. Some methods according to embodiments of the invention may also include observing faster germination or greater germination rate from treated seeds as opposed to untreated seeds. Some methods according to this aspect of the invention may also include observing improved stress tolerance characteristics of plants from treated seeds. Some methods according to this aspect of the invention may also include growing the treated seeds according to schedules or guidance that predict or assume faster germination or greater germination rate as compared with untreated seeds of the same type. Additionally, some methods may include growing the treated seeds into juvenile plants and observing other effects of the jasmonate treatments, including effects on plant yield, tissue biochemical composition, trichome development, rate of development, leaf senescence, browning, and wilting. These methods may include exposing the jasmonate treated seeds or plants to various abiotic or biotic stresses and observing the above effects as characteristics for stress tolerance.

Another aspect of the invention relates to seed treatment methods for improving germination and/or stress tolerance characteristics. The methods include soaking seed(s) (dormant, non-germinating seeds, and/or germinating seeds) for a defined period of time in a liquid medium including one or more jasmonates, such as MDHJ. In one embodiment, seed(s) are soaked at jasmonate concentrations of about 1.5 mM or less, such as an MDHJ concentration of about 1.5 mM or less. The methods may also involve storing the treated seed for a period of time, and, ultimately, planting the treated seeds. In some embodiments, the defined period of time for soaking the seeds may be about 24 hours. Some methods according to this aspect of the invention may also include growing the treated seeds according to schedules or guidance that predict or assume faster germination, or greater germination rate, or improved plant yield, improved rate of development, reduced leaf senescence, reduced browning, and reduced wilting. The latter may be observed in juvenile or mature plants originating from the treated seeds.

Yet another aspect of the invention relates to a method for cultivating a plant. The method includes planting seed(s) (dormant, non-germinating seeds, and/or germinating seeds) and, at the time of planting, with the first watering, and/or prior to radicle emergence, soaking the soil with a liquid medium that includes an effective amount of one or more jasmonates, such as MDHJ. The effective amount may be an amount that produces the same or about the same exposure of the seeds to MDHJ and/or another jasmonate as a 24 hour soak of the seeds in an aqueous solution of MDHJ and/or another jasmonate with a concentration of about 1.5 mM or less. However, other effective amounts and times may be chosen based on the type of seed, soil conditions, and particular formulation of jasmonate(s) used, such as those provided above and below. The method may also include soaking the soil with a liquid medium that contains an effective amount of one or more jasmonate, such as MDHJ, after radicle emergence of the seed. The method may also include soaking the soil with a liquid medium containing an effective amount of one or more jasmonate, such as MDHJ, prior to, during, and after radicle emergence of the seed.

Yet another aspect of the invention relates to a method for cultivating a plant which includes exposing seed(s) (dormant, non-germinating seeds, and/or germinating seeds) to a solid preparation or liquid formulation containing an effective amount of one or more jasmonates, such as MDHJ, and planting the exposed seed. The effective amount may be an amount of jasmonate, such as MDHJ, that produces the same or about the same exposure of the seeds to MDHJ and/or another jasmonate as a 24 hour soak of the seeds in an aqueous solution of MDHJ and/or another jasmonate with a concentration of about 1.5 mM or less. However, other effective amounts and times may be chosen based on the type of seed, soil conditions, and particular formulation of jasmonate(s) used. The method may also include application of an effective amount of one or more jasmonate, such as MDHJ, to the seed in a solid preparation after radicle emergence of the seed. The method may also include application of an effective amount of one or more jasmonates, such as MDHJ, to the seed in a solid preparation prior to, during, and after radicle emergence of the seed.

A further aspect of the invention relates to kits for treating seeds (dormant, non-germinating seeds, and/or germinating seeds) with one or more jasmonates, such as MDHJ, and optionally prior to radicle emergence. The kits may include seeds, soaking containers, and one or more jasmonates in a concentrated liquid or solid form, along with instructions for diluting or constituting the liquid or solid into a liquid treatment medium with a jasmonate concentration or amount sufficient to improve the germination characteristics of the seeds and instructions for applying the liquid treatment medium to the seeds.

An additional aspect of the invention is treating juvenile or adult plants with one or more jasmonates, such as MDHJ, after planting of seeds. The one or more jasmonates may be applied to the roots, foliage, flowers, stem, branches, fruits, or other parts of the plants. The one or more jasmonates may be applied to the plants after treatment or without treatment of seeds with one or more jasmonates. The one or more jasmonates, such as MDHJ, may be applied to the juvenile or adult plants and one or more stress tolerance characteristics may be observed.

An additional aspect of the invention relates to a liquid formulation comprising one or more jasmonates, such as MDHJ, at a concentration of 1.5 mM or less, and a solid formulation comprising one or more jasmonates, such as MDHJ, that when applied to a seed produces exposure to the jasmonate(s) at least equivalent to a 24 hour soak of the seed in a 1.5 mM solution of MDHJ and/or another jasmonate in water.

An additional aspect of the invention relates to seeds treated before, during, or after radicle emergence with one or more jasmonates, such as MDHJ, in an amount effective to improve a germination characteristic or stress tolerance characteristic of the seed.

Particular aspects of the invention include Aspect 1, a method of seed treatment comprising exposing a seed to methyl dihydrojasmonate (MDHJ) at an amount and duration effective for improving a germination characteristic of the seed or at an amount and duration effective for improving a stress tolerance characteristic of a seedling or plant resulting from the seed. Aspect 2 is the method of Aspect 1, wherein the MDHJ is present in a liquid or solid formulation. Aspect 3 is the method of Aspect 2, wherein the MDHJ is present in the liquid formulation at a concentration of 0.05 mM to 100 mM. Aspect 4 is the method of Aspect 3, wherein the MDHJ is present in the liquid formulation at a concentration of 1.5 mM to 20 mM. Aspect 5 is the method of Aspect 4, wherein the MDHJ is present in the liquid formulation at a concentration of 4.5 mM to 10 mM. Aspect 6 is the method of Aspect 2, wherein the MDHJ is present in the liquid formulation at a concentration of 0.15 mM to 4.5 mM. Aspect 7 is the method of Aspect 2, wherein the MDHJ is present in the solid formulation at a concentration of 0.001% to 1.0% by weight.

Aspect 8 is the method of any of Aspects 1-7, wherein exposing the seed to the MDHJ produces an exposure of the seed that is at least equivalent to a 24 hour soak in a 1.5 mM solution of MDHJ in water.

Aspect 9 is the method of Aspect 1, wherein the MDHJ is present in an aqueous solution containing 0.05 mM to 1.5 mM of MDHJ.

Aspect 10 is the method of any of Aspects 1-9, further comprising providing the seed, where the seed is at a stage in development that is prior to radicle emergence.

Aspect 11 is the method any of Aspects 1-9, further comprising providing the seed, where the seed is at a stage in development that is after radicle emergence.

Aspect 12 is the method of any of Aspects 1-11, wherein the germination characteristic of the seed is germination rate, rate of development, vigor, or yield of mature plants originating from the seed.

Aspect 13 is the method of any of Aspects 1-12, wherein the exposing of the seed to the MDHJ comprises planting the seed in soil and applying the MDHJ to the soil.

Aspect 14 is the method any of Aspects 1-13, wherein the improvement of a stress tolerance characteristic comprises increased yield, increased growth rate, decreased browning, decreased wilting, and/or decreased leaf senescence.

Aspect 15 is the method of any of Aspects 1-14, wherein the stress tolerance characteristic is resistance to an abiotic stress selected from the group consisting of drought, salt stress, osmotic stress, cold stress, heat stress, temperature stress, mechanical stress, stress from wetness, nutrient deficiency, nutrient excess, radiation stress, atmospheric pollution, soil pollution, soil quality, and soil pH.

Aspect 16 is the method of any of Aspects 1-15, wherein the stress tolerance characteristic is resistance to a biotic stress selected from the group consisting of bacteria, viruses, fungi, parasites, insects, weeds, other plants, and herbivores.

Aspect 17 is a seed comprising an amount of MDHJ effective for improving a germination characteristic or a stress tolerance characteristic of a seedling or plant resulting from the seed. Aspect 18 is the seed of Aspect 17, wherein the amount of MDHJ produces an exposure of the seed that is at least equivalent to a seed soak in an aqueous solution of MDHJ at a concentration of up to 1.5 mM for 24 hours.

Aspect 19 is a method of seed treatment comprising exposing a seed to one or more jasmonates at an amount and duration effective for improving a germination characteristic of the seed or at an amount and duration effective for improving a stress tolerance characteristic of a seedling or plant resulting from the seed.

Aspect 20 is the method of Aspect 19, wherein the jasmonate is present in a liquid or solid formulation. Aspect 21 is the method of Aspect 19 or 20, wherein the jasmonate is present in the liquid formulation at a concentration of 0.05 mM to 100 mM. Aspect 22 is the method of any of Aspects 19-21, wherein the jasmonate is present in the liquid formulation at a concentration of 1.5 mM to 20 mM. Aspect 23 is the method any of Aspects 1-22, wherein the jasmonate is present in the liquid formulation at a concentration of 4.5 mM to 10 mM. Aspect 24 is the method of any of Aspects 1-23, wherein the jasmonate is present in the liquid formulation at a concentration of 0.15 mM to 4.5 mM. Aspect 25 is the method of Aspect 20, wherein the jasmonate is present in the solid formulation at a concentration of 0.001% to 1.0% by weight.

Aspect 26 is the method of any of Aspects 19-25, wherein exposing the seed to the jasmonate produces an exposure of the seed that is at least equivalent to a 24 hour soak in a 1.5 mM solution of the jasmonate in water.

Aspect 27 is the method of Aspect 19, wherein the jasmonate is present in an aqueous solution containing 0.05 mM to 1.5 mM of the one or more jasmonates.

Aspect 28 is the method of any of Aspects 19-27, further comprising providing the seed, where the seed is at a stage in development that is prior to radicle emergence.

Aspect 29 is the method of any of Aspects 19-27, further comprising providing the seed, where the seed is at a stage in development that is after radicle emergence.

Aspect 30 is the method of any of Aspects 19-29, wherein the germination characteristic of the seed is germination rate, rate of development, vigor, or yield of mature plants originating from the seed.

Aspect 31 is the method of any of Aspects 19-30, wherein the exposing of the seed to the one or more jasmonates comprises planting the seed in soil and applying the jasmonate to the soil.

Aspect 32 is the method of any of Aspects 19-31, wherein the improvement of a stress tolerance characteristic comprises increased yield, increased growth rate, decreased browning, decreased wilting, and/or decreased leaf senescence.

Aspect 33 is the method of any of Aspects 19-32, wherein the stress tolerance characteristic is resistance to an abiotic stress selected from the group consisting of drought, salt stress, osmotic stress, cold stress, heat stress, temperature stress, mechanical stress, stress from wetness, nutrient deficiency, nutrient excess, radiation stress, atmospheric pollution, soil pollution, soil quality, and soil pH.

Aspect 34 is the method of any of Aspects 19-33, wherein the stress tolerance characteristic is resistance to a biotic stress selected from the group consisting of bacteria, viruses, fungi, parasites, insects, weeds, other plants, and herbivores.

Aspect 35 is a seed comprising an amount of one or more jasmonates effective for improving a germination characteristic or a stress tolerance characteristic of a seedling or plant resulting from the seed. Aspect 36 is the seed of Aspect 35, wherein the amount of jasmonate produces an exposure of the seed that is at least equivalent to a seed soak in an aqueous solution of the jasmonate at a concentration of up to 1.5 mM for 24 hours.

Aspect 37 is a method of seed treatment comprising soaking for up to 48 hours a dormant, non-germinating, or germinating seed in a treatment composition comprising methyl dihydrojasmonate (MDHJ) present at a concentration ranging from 0.05 mM to 20 mM. Aspect 38 is the method of Aspect 37, wherein the soaking is for 1 minute to 48 hours. Aspect 39 is the method of Aspect 37 or 38, wherein the soaking is for 1 minute to 2 hours. Aspect 40 is the method of any of Aspects 37-39, wherein the soaking is for 30 minutes to 1 hour. Aspect 41 is the method of any of Aspects 37-40, wherein the seed is soaked in water for 1 hour to 72 hours to provide a germinating seed prior to soaking the seed in the treatment composition.

Aspect 42 is a kit for treating a seed with a treatment composition, the kit comprising: methyl dihydrojasmonate (MDHJ) in liquid or solid form; and instructions for treating a seed with the MDHJ in a manner that provides for improving a germination characteristic of the seed or provides for improving a stress tolerance characteristic of a seedling or plant resulting from the seed. Aspect 43 is the kit of Aspect 42, wherein the MDHJ is present in liquid form at a concentration of 0.15 mM to 100 mM. Aspect 44 is the kit of any of Aspects 42-43, wherein the MDHJ is present in liquid form at a concentration of up to 10 mM, up to 20 mM, up to 50 mM, or up to 100 mM. Aspect 45 is the kit of any of Aspects 42-44, further comprising seeds and/or soaking containers. Aspect 46 is the kit of Aspect 42, wherein the MDHJ is present in solid form. Aspect 47 is the kit of Aspect 46, wherein the instructions provide a procedure for preparing a liquid formulation of the MDHJ at a concentration ranging from 0.05 mM to 20 mM.

Aspect 48 is the method of any of Aspects 1-47, wherein 25%-40% of the MDHJ is present as an epi- or cis-isomer of a compound of Formula (4):

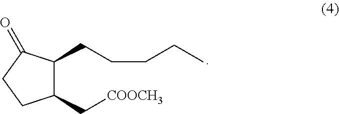 [SMILES: CCCCC[C@@H]1C(=O)CC[C@@H]1CC(=O)OC]

Aspect 49 is the kit of any of Aspects 42-47, wherein 25%-40% of the MDHJ is present as an epi- or cis-isomer of a compound of Formula (4):

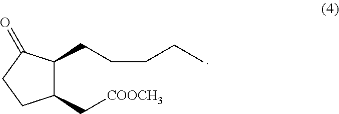 [SMILES: CCCCC[C@@H]1C(=O)CC[C@@H]1CC(=O)OC]

Aspect 50 is a method of seed treatment comprising exposing a plant or plant part to one or more jasmonates in volatilized form. Aspect 51 is the method of Aspect 50, wherein the jasmonate is MDHJ. Aspect 52 is the method of Aspect 50 or 51, wherein the exposing comprises applying the jasmonate as a liquid or solid preparation capable of emitting jasmonate vapors and within a vicinity of the plant or plant part sufficient to expose the plant or plant part to the jasmonate vapors. Aspect 53 is the method of any of Aspects 50-52, wherein the jasmonate is applied to soil. Aspect 54 is the method of any of Aspects 50-53, wherein the jasmonate is a liquid preparation and the applying is performed by spraying the soil with the liquid preparation. Aspect 55 is the method of any of Aspects 50-53, wherein the jasmonate is a solid preparation and the applying is performed by contacting the solid preparation with the soil. Aspect 56 is the method of Aspect 55, wherein the applying is performed by incorporating the solid preparation into the soil.

Aspect 57 is a seed prepared using the method of any of Aspects 1-16, 19-34, 37-41, 48, or 50-56. Aspect 58 is a seed prepared using the kit of any of Aspects 42-47 or 49.

Aspect 59 is a liquid formulation comprising MDHJ at a concentration between 25 mM and 100 mM, inclusive. Aspect 60 is a solid formulation comprising MDHJ at a concentration between 2% and 10%, inclusive.

Aspect 61 is the seed of Aspect 35, which is a vegetable seed. Aspect 62 is the seed of Aspect 35, which is a fruit seed.

Aspect 63 is the method of any of Aspects 1-16 or 19-34, wherein the exposing step is performed before planting of the seed in soil. Aspect 64 is the method of any of Aspects 1-16 or 19-34, wherein the exposing step is performed during planting of the seed in soil. Aspect 65 is the method of any of Aspects 1-16 or 19-34, wherein the exposing step is performed after planting of the seed in soil. Aspect 66 is the method of any of Aspects 1-16 or 19-34, further comprising planting the seed, and exposing one or more parts of a juvenile or adult plant originating from the seed to MDHJ.

Aspect 67 is the method of Aspect 66, wherein MDHJ is applied to the roots, foliage, stem, branches, flowers, or fruits or the juvenile or adult plant originating from the seed.

These and other aspects, features, and advantages of the invention will be set forth in the description that follows.

### BRIEF DESCRIPTION OF THE DRAWING FIGURES

The accompanying drawings illustrate certain aspects of embodiments of the present invention, and should not be used to limit the invention. Together with the written description the drawings serve to explain certain principles of the invention.

FIG. 1 is a photograph of representative corn seeds, both untreated and treated with various concentrations of MDHJ, shown several days after treatment.

FIG. 2 is a graph illustrating average radicle length of corn seeds, both untreated and treated with various concentrations of MDHJ.

FIG. 3 is a photograph of lettuce plants grown from untreated and MDHJ-treated seeds, shown two weeks after planting.

FIG. 4 is a graph showing radicle length of tomato seeds, both untreated germinating seeds and treated germinating seeds, with various concentrations of MDHJ.

FIG. 5 is a graph showing coleoptile length of wheat seeds, both untreated germinating seeds and treated germinating seeds, with various concentrations of MDHJ.

FIG. 6 is a graph showing growth of corn seeds, both untreated germinating seeds and treated germinating seeds, with various concentrations of MDHJ.

### DETAILED DESCRIPTION OF VARIOUS EMBODIMENTS OF THE INVENTION

Reference will now be made in detail to various exemplary embodiments of the invention. It is to be understood that the following discussion of exemplary embodiments is not intended as a limitation on the invention. Rather, the following discussion is provided to give the reader a more detailed understanding of certain aspects and features of the invention.

The inventors have discovered that treatment of plant seeds with methyl dihydrojasmonate (MDHJ) prior to radicle emergence surprisingly increases the germination rate and the speed at which those seeds germinate as compared with untreated control groups.

Moreover, as will be explained below in more detail, even in plants in which MDHJ seed treatment did not appear to increase the germination rate or the speed of germination, surprisingly, MDHJ treatment at particular concentrations or in particular amounts also did not appear to retard germination. This may allow a seed to be treated with MDHJ and/or another jasmonate prior to radicle emergence for other reasons—e.g., pest resistance in the established plant—without substantially reducing the chance that the seed will germinate.

As used in this description, the term “germination rate” refers to the percentage of seeds that germinate from a group of seeds that are planted or otherwise placed in conditions that promote germination. The terms “speed of germination” and “faster germination,” as used here, refer to the time span over which a radicle emerges.

Germination itself may be considered by at least some authorities to be complete once a radicle has emerged. Although this description refers to the effects of MDHJ and/or another jasmonate on “germination,” as the present inventors have discovered, MDHJ may also affect some aspects of early seedling development—like radicle length. The phrase “germination characteristics” is meant to encompass germination rate and speed of germination per se, as well as effects on early seedling development that are caused or mediated by exposure to MDHJ and/or another jasmonate. Moreover, the phrase “prior to radicle emergence,” is used to mean that the seeds may either be entirely non-germinated or at some perceptible or imperceptible early stage of the germination process. Some signs of germination, like seed swelling, are easily perceptible, while others are not. The phrase “after radicle emergence,” means perceptible emergence of the embryonic root of the plant from the plumule.

Additionally, as will be described further below, MDHJ and/or other jasmonates may alternatively, or in addition to improving germination characteristics of plants, may also improve stress tolerance characteristics of plants. The stress tolerance characteristics may include resistance to or amelioration of symptoms of abiotic or biotic stress. In one embodiment, the stress tolerance characteristics include improvement of one or more germination characteristics of the plant in the presence of stress. The improvement in stress tolerance may occur as a result of treatment with MDHJ and/or another jasmonate at any stage, including dormant seeds, non-germinating seeds, germinating seeds, juvenile plants, and mature plants.

Plants to which MDHJ and/or another jasmonate may be applied to improve germination and/or stress tolerance include, but are not limited to, angiosperms, gymnosperms, monocots, dicots, roses, tomatoes, crop plants, ornamental plants, turf plants, shrubs, trees, exotic plants, house plants, and native plants in cultivated or natural environments. MDHJ and/or another jasmonate may also be applied to plants grown for food. MDHJ has been found to be particularly effective in improving germination in corn. However, the invention includes applications of MDHJ and/or another jasmonate to seeds or adult plants of a variety of crops, including grains, fruits, and vegetables, for improving germination or stress tolerance characteristics, including without limitation alfalfa, almond, apple, artichoke, arugula, asparagus, avocado, banana, barley, beans, beet, bell peppers, blackberry, black-eyed bean, blueberry, broad bean, broccoli, brussels sprouts, butternut squash, cabbage, cannabis, capers, carrots, cauliflower, celery, cereals, chard, chilies, clover, coconut, coffee, cotton, cucumber, eggplant, endive, fennel, flowers, fruits, garlic, ginger, green bean, haricot bean, herbs, horseradish, jicama, kale, kohlrabi, leek, legumes, lettuce, macadamia, mandarin orange, mango, millet, mushrooms, oat, okra, olive, onion, orange, parsnips, peanut, pear, peas, pecan, peppers, pineapple, pistachio, pomegranate, pumpkin, radishes, rapeseed, raspberry, rhubarb, rice, rutabagas, rye, scallions, shallots, sorghum, soy, spinach, squash, string bean, sugar beet, sunflower, sweet potato, tangerine, tobacco, tomatoes, turnip, vegetables, walnut, watercress, wheat, yams, zucchini, and the like. One of skill in the art will recognize that these varieties are provided herein only as representative examples of the type of crops and plants that the inventive compositions and methods can be used with.

To improve seed germination or stress tolerance characteristics, the MDHJ and/or other jasmonate may be applied alone or in a formulation comprising other elements, compounds, or substances. In many embodiments, the MDHJ and/or other jasmonate will be applied in the form of an aqueous solution, but solid preparations, liquid suspensions, and preparations that allow the MDHJ and/or other jasmonate to volatilize and expose the plant to jasmonate vapors may also be used. Some examples of other compounds that may be included in the formulation include wetting agents, adjuvants, emulsifiers, dispersants, spreaders, stickers, pastes, anchorage agents, fixatives, extenders, coating agents, buffering agents, plant nutrients, absorptive additives, and disintegrants. The formulation may also include acids, bases, or other compounds that adjust or maintain the final pH of the formulation in order to increase solubility of certain compounds in the formulation or for other reasons. Those of skill in the art will recognize that a single ingredient may perform multiple functions, and may thus be classified or grouped in different ways. The formulation may also include plant nutrients, plant growth regulators, plant defense activators, pesticides, insecticides, herbicides, fungicides, beneficial microbes or other active compounds.

In a typical embodiment, prior to radicle emergence, seeds would be soaked for a defined period of time in an aqueous solution including MDHJ and/or another jasmonate at a particular concentration. Following the soak, the seeds may immediately be planted or may be dried for later planting. In some embodiments, there may be a delay of days, weeks, months, or longer between the treatment of the non-germinated seeds and their planting, and seeds may be stored, preferably under controlled conditions, before they are planted. As one example of a treatment protocol, seeds may be soaked for up to 24 hours in an aqueous solution of MDHJ and/or another jasmonate. The concentration of MDHJ and/or other jasmonate in the solution may vary depending on the plant type and species and a number of other factors. For example, the concentration may be equal to or less than about 1.5 mM in some embodiments. Shorter soak times with higher concentrations of MDHJ and/or another jasmonate may also be used.

While direct soaking or treatment of seeds may be the preferred mode of treatment in some embodiments, solutions, suspensions, and other preparations of MDHJ and/or another jasmonate may be applied to seeds in other ways. For example, an MDHJ and/or other jasmonate solution or suspension could be applied as a soil drench to seeds at the time of planting, at the first watering, or any other time prior to germination. Other methods of exposing seeds to MDHJ and/or another jasmonate may also be used. For example, seeds may be manually or mechanically coated with a solid preparation that includes MDHJ and/or another jasmonate and one or more components that assist the MDHJ and/or another jasmonate in adhering to the seeds. When the seeds are exposed to water, the MDHJ and/or other jasmonates will form a solution or suspension of a concentration appropriate for treating the seeds. As those of skill in the art will realize, although portions of this description may refer to soaking in MDHJ and/or other jasmonate solutions, preparations of MDHJ and/or other jasmonates that result in an equivalent or near equivalent exposure may be used.

Treated seeds may also be produced by providing a plant or part thereof, exposing the plant or plant part to a composition comprising MDHJ and/or another jasmonate, optionally present in a concentration ranging from 0.01 mM to 100 mM, growing the plant to produce seeds from the plant, wherein the seeds comprise an improved germination characteristic of the seed, or an improved stress tolerance characteristic of a seedling or plant resulting from the seed.

The MDHJ and/or other jasmonate may be applied alone or in a formulation comprising other elements, compounds, or substances. Some examples of other compounds that may be included in the formulation include wetting agents, adjuvants, emulsifiers, dispersants, spreaders, stickers, pastes, anchorage agents, fixatives, extenders, coating agents, buffering agents, plant nutrients, absorptive additives, and disintegrants. The formulation may also include acids, bases, or other compounds that adjust or maintain the final pH of the formulation in order to increase solubility of certain compounds in the formulation or for other reasons. Those of skill in the art will recognize that a single ingredient may perform multiple functions, and may thus be classified or grouped in different ways.

Particular examples of formulation ingredients include ionic, non-ionic, and zwitterionic surfactants, such as TRITON® X-100, TRITON® X-114, NP-40, SILWET, Tween 20 (polysorbates) and sodium dodecyl sulfate; alcohols; synthetic or natural oils, such as castor oil, canola (rapeseed) oil, and soybean oil; soaps; and adjuvants derived from natural sources, such as lecithin, saponin, cocodiethanolamide, and extracts from yucca, coconut, and pine. Additionally, for example, citric acid may be used to acidify a formulation, and compounds such as dipotassium phosphate, calcium carbonate, and potassium silicate may be used to raise the pH.

In some embodiments, it may be beneficial to use ingredients that are high in compounds that play a role in the octadecanoic pathway. For example, canola oil is high in linoleic and linolenic acids, compounds that play a role in the octadecanoic pathway. Soaps of linoleic, linolenic, and cis-7,10,13-hexadecatrienoic acids may also be desirable formulation ingredients in some embodiments.

An MDHJ and/or other jasmonate formulation used in embodiments of the invention may also include fixative and extender compounds, in order to reduce volatility and evaporation of the active ingredient or ingredients, so as to increase exposure of the plant to the active ingredient. Exemplary fixatives include canola oil, castor oil, benzoyl benzoate, benzyl salicylate and synthetic musks, and sandalwood. Gums, waxes, and other carbohydrates, such as carnauba wax, carob gum, dextrins, dextrose, gellan gum, guar gum, paraffin wax, sorbitol, xanthan gum, polyvinylpyrrolidone, and glycerin, may also be used as fixatives.

Absorptive additives may also be included for extending the release and exposure time. Exemplary absorptive additives include, but are not limited to, silica gel; precipitated crystalline-free silica gel; amorphous, fumed, crystalline-free silica; amorphous, precipitated gel silica; silica hydrate; vitreous silica; silicic acid; and silicon dioxide.

Alone or in combination with other ingredients, the MDHJ and/or other jasmonate may be delivered in the form of emulsions, suspensions, powders, hydrates, solutions, granules, pastes, aerosols, and volatile formulations. If MDHJ and/or another jasmonate is delivered in the form of a solution, it may be in solution with any compatible solvent, including aqueous (water) solutions, alcohol (e.g., ethanol) solutions, or in combinations of solvents (e.g., water/ethanol.) In general, a “compatible solvent,” as the term is used here, refers to any solvent in which MDHJ and/or another jasmonate is at least slightly soluble and which is not phytotoxic in the amounts or concentrations used to apply the MDHJ and/or other jasmonate.

Alone or in combination with other ingredients, seed treatments with MDHJ and/or another jasmonate may be combined with other products, including fertilizers, herbicides, pesticides, fungicides, miticides, microbials, plant growth regulators, insecticides, growth stimulators, and other defense activators.

In addition to seed treatment, forms of MDHJ and/or other jasmonates may be adapted for application to the plant's foliage, roots, stems, and flowers. Particularly advantageous forms include foliar sprays, root solutions, and pellet-based root preparations. As a root solution or preparation, jasmonates such as MDHJ may be formulated and applied to plants grown in soil, non-soil, artificial growing media, and/or hydroponic systems. In some embodiments, the jasmonate formulations may be combined with other active compounds that can be administered in the same fashion as the jasmonate formulation. Examples include fertilizers, seaweed, kelp, humic acid, and microbes. MDHJ and/or other jasmonates may also be formulated for volatile applications to non-germinating/germinating seedlings. An MDHJ foliar spray may be combined with a foliar fertilizer, and a root solution may be combined with a fertilizer that is applied to the roots. Specific fertilizer and plant nutrient elements include, but are not limited to, nitrogen, potassium, phosphorus, calcium, magnesium, which may be compounded in any known manner so as to be absorbable by the plant. For example, plant nutrients may include monobasic potassium phosphate (KH2PO4) and magnesium sulfate (MgSO4).

In addition to or alternatively to the above ingredients, formulations according to embodiments of the invention may also include preservatives. For example, suitable preservatives may include potassium sorbate, sodium benzoate, sulfites, sodium nitrite, EDTA, and calcium propionate, to name a few.

As was noted above, the MDHJ and/or other jasmonate is applied in an “effective amount” to improve seed germination, seedling establishment and/or stress tolerance. For purposes of this description, an effective amount of MDHJ and/or other jasmonate is any amount of MDHJ and/or other jasmonate that produces a noticeable increase in seed germination or improvement in stress tolerance characteristic as compared with untreated seeds. As was noted above, the MDHJ and/or other jasmonate is applied in an “effective amount” to improve seed germination or a stress tolerance characteristic. For purposes of this description, an effective amount of MDHJ and/or other jasmonate is any amount of MDHJ and/or other jasmonate that produces a noticeable increase in seed germination or improvement in stress tolerance characteristic as compared with untreated plants. Further, in some embodiments, improvements in seed germination may serve as a stress tolerance characteristic.

Embodiments of the invention include a seed treatment method comprising: exposing a seed to an effective amount of methyl dihydrojasmonate (MDHJ) and/or other jasmonate and for a time effective for improving a germination characteristic of the seed.

Effective amounts of MDHJ and/or other jasmonates will vary from species to species and cultivar to cultivar, and will depend on the manner of application, the environmental conditions around the seed, plant or plants, the form in which the MDHJ is administered, and the nature and type of additive compounds, if any, present in the formulation with the MDHJ. Thus, different concentrations and exposure times for any given formulation will vary according to the type of plant and variety. The concentration will also vary depending on whether dormant, non-germinating or germinating seeds are treated.

For example, if an MDHJ and/or other jasmonate formulation is applied using a formulation that includes wetting agents, fixatives, and/or other additives intended to increase the level of exposure of the seed to the MDHJ and/or other jasmonate, or is applied over a substantial portion of a plant's foliage, the formulation itself may contain a smaller amount or lower concentration of MDHJ and/or other jasmonate than if a formulation is applied over only a small portion of a plant's foliage, or without additives intended to increase the plant's or seed's exposure to the MDHJ and/or other jasmonate. Similarly, if the MDHJ and/or other jasmonate is administered in a form that tends to linger on the plant's seed or foliage, or in proximity to another part of the plant, then it may be administered in a lower concentration or amount.

As one example, an effective amount of MDHJ and/or other jasmonate for improving seed germination or a stress tolerance characteristic may comprise a formulation with an MDHJ and/or other jasmonate concentration in the range from about 0.05 mM to about 10 mM, inclusive, such as from about 0.15 mM to about 10 mM. However, for some purposes and some applications, and in some species, concentrations up to or greater than 20 mM, including 50 mM and 100 mM may be used. As those of skill in the art will realize, in general, MDHJ and/or other jasmonates may be used in even higher concentrations for some applications, provided that the total dose of MDHJ and/or other jasmonates that is absorbed by the plant is not phytotoxic. However, in other embodiments, the seeds (whether dormant, non-germinating seeds, and/or germinating seeds) may be exposed to jasmonate concentrations of greater than 1.5 mM, including 3 mM, 5 mM, 10 mM, 20 mM, 50 mM, and 100 mM. In another embodiment, the seeds may be exposed to jasmonate concentrations, such as MDHJ, of about 1.5 mM or less, including 1.0 mM, 0.50 mM, 0.25 mM, 0.15 mM, and 0.05 mM. Similarly, lower jasmonate concentrations may be adequate in some situations, for example, in an enclosed environment or greenhouse. In another example, an effective amount may be less than 0.15 mM, including 100 μM, 50 μM, 20 μM, 10 μM, 5 μM, 2 μM, and 1 μM.

In one embodiment, seeds may be soaked in a jasmonate concentration for a predefined amount of time, such as, for example, 24 hours. In other embodiments, the predefined amount of time may be lesser than 24 hours, including 1, 2, 4, 8, 12, 16, and 20 hours, or greater than 24 hours, including 36, 48, 60, 72, 96 hours, or time frames spanning weeks. In some embodiments, exposure to higher concentrations may be briefer in duration than exposure to lower concentrations and vice versa, to adjust for the amount of MDHJ and/or other jasmonate absorbed by the seed. As an illustrative hypothetical example, seeds soaked in a 10 mM solution of MDHJ for 1 hour may take up an equivalent amount of MDHJ as seeds soaked in a 1 mM solution of MDHJ for 12 hours. However, it is within the abilities of a skilled artisan to test different formulations (solid or liquid) of MDHJ at different concentrations and measure the uptake of MDHJ in the seed. For example, in one embodiment, fixed amounts of seeds are exposed to different liquid and solid formulations of MDHJ as different intervals in conical test tubes. The seeds are kept continually exposed to the seeds by stirring or agitation of the solution or solid suspension. After the set interval is expired, the seeds are transferred from the test tubes and the formulation is removed by through rinsing with water. The absorbed MDHJ content of the seeds is then extracted from the seeds by emersion of the seeds in a polar solvent such as ethanol or methanol, or a non-polar solvent such as hexane or chloroform. To facilitate extraction, it may be necessary to fracture or grind the seed. The MDHJ content of the extracts are then measured by gas chromatography or HPLC based on standard solutions of MDHJ in the solvent. Using these methods, it is possible to determine which formulations of MDHJ and exposure times produce equivalent exposures. In one embodiment, these methods are used to determine a formulation, concentration, and duration that produces an exposure at least equivalent to a 24 hour soak in a 1.5 mM solution of MDHJ in water. Parts of the seeds that may take up MDHJ after exposure may include the seed coat or cuticle, as well as interior portions of the seed such as the cotyledon, epicotyl, hypocotyl, endosperm, and radicle.

As another example, a formulation with an effective amount of MDHJ and/or other jasmonate may produce the same or about the same exposure to MDHJ and/or other jasmonate as a 24 hour soak in an MDHJ and/or other jasmonate concentration of about 1.5 mM or less in water.

In one embodiment, an effective amount may be equivalent to a 24 hour exposure to MDHJ and/or other jasmonate with a concentration of about 1.5 mM or less. For example, an effective amount of MDHJ and/or other jasmonate may produce an equivalent exposure to MDHJ and/or other jasmonate as a 24 hour soak in an MDHJ and/or other jasmonate concentration of about 1.5 mM or less in water.

To produce exposures equivalent to a 24 hour soak in an MDHJ and/or other jasmonate concentration of about 1.5 mM or less in water, MDHJ and/or another jasmonate may be present in a specific formulation at a range of concentrations. This is because such exposures may have different variables, including the other constituents of the formulation in which MDHJ and/or another jasmonate is present and the amount of time of exposure, soil conditions, frequency of watering, temperature, etc. For example, other constituents may effect penetration into the seed or release from the formulation, soil conditions may affect stability of the formulation, and temperature may affect volatility of MDHJ and/or other jasmonates in the formulation. In field applications (i.e. environmental settings), the amount of time of exposure may be more difficult to control due to effects on the weather (e.g. wind, precipitation).

In one embodiment, seeds exposed for 24 hours or less to one or more jasmonates (such as MDHJ) present in a formulation at a concentration of 1.5 mM to 50 mM produces an exposure equivalent to a 24 hour soak in an MDHJ concentration of about 1.5 mM or less in water. In another embodiment, seeds exposed for 24 hours or less to MDHJ present in a formulation at a concentration of 1.5 mM to 20 mM produces an exposure equivalent to a 24 hour soak in an MDHJ concentration of about 1.5 mM or less in water. In another embodiment, seeds exposed for 24 hours or less to MDHJ present in a formulation at a concentration of 1.5 mM to 10 mM produces an exposure equivalent to a 24 hour soak in an MDHJ concentration of about 1.5 mM or less in water. In another embodiment, seeds exposed for 24 hours or less to MDHJ present in a formulation at a concentration of 1.5 mM to 4.5 mM produces an exposure equivalent to a 24 hour soak in an MDHJ concentration of about 1.5 mM or less in water. In another embodiment, seeds exposed for 24 hours or less to MDHJ present in a formulation at a concentration of 4.5 mM to 50 mM produces an exposure equivalent to a 24 hour soak in an MDHJ concentration of about 1.5 mM or less in water. In another embodiment, seeds exposed for 24 hours or less to MDHJ present in a formulation at a concentration of 4.5 mM to 20 mM produces an exposure equivalent to a 24 hour soak in an MDHJ concentration of about 1.5 mM or less in water. In another embodiment, seeds exposed for 24 hours or less to MDHJ present in a formulation at a concentration of 4.5 mM to 10 mM produces an exposure equivalent to a 24 hour soak in an MDHJ concentration of about 1.5 mM or less in water. Again, the exact concentration to produce an equivalent exposure will depend on the constituents of the formulation (such as those described above), environmental conditions in which it is applied, and duration of exposure. Alternatively, seeds may be exposed for more than 24 hours at lower concentrations or under cold conditions.

In embodiments, 25%-40% of the MDHJ is present as an epi- or cis-isomer of a compound of Formula (4):

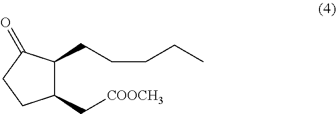 [SMILES: CCCCC[C@@H]1C(=O)CC[C@@H]1CC(=O)OC]

In embodiments, exposing of the seed to the MDHJ and/or another jasmonate comprises soaking seeds (whether dormant, non-germinating seeds, and/or germinating seeds) in a liquid medium. In one embodiment, the soak solution comprises MDHJ and/or another jasmonate at a concentration of about 1.5 mM or less. In another embodiment, the soak solution comprises MDHJ and/or another jasmonate at a concentration of 0.15 mM to 1.5 mM. In another embodiment, the liquid medium is water. In another embodiment, the liquid medium is an aqueous solution. The aqueous solution may optionally include one more wetting agents such as surfactants and one or more buffers for adjusting the pH of the solution.

In embodiments, exposing of the seed to the MDHJ and/or another jasmonate comprises planting the seed in soil and soaking the soil with MDHJ and/or another jasmonate by applying MDHJ to the soil. Some embodiments may include first soaking the seed prior to planting and then continuously exposing the seed to MDHJ and/or another jasmonate after planting by repeatedly applying a liquid formulation of MDHJ and/or other jasmonate to the soil. The concentration of the soak solution may differ from the concentration of the solution applied to soil. It may be desirable to soak the soil with the MDHJ and/or other jasmonate solution repeatedly at scheduled waterings. The MDHJ and/or other jasmonate solutions can be applied daily, on alternative days, once every three days, once a week, or at varying intervals, repeatedly for up to several weeks after planting.

The effective amount may be applied to the seed at a stage in development that is prior to radicle emergence, for example, a non-germinated seed. However, in other embodiments, the effective amount may be applied to the seed in a stage of development that is after radicle emergence (i.e. a germinating seedling). Even further, the effective amount may be applied to the seeds in a stage of development that is during germination, such as after soaking the seeds in water. The treated seeds may be non-germinated seeds, germinated seeds, or dormant seeds. The germinated seeds may be treated either before or after planting in the soil. The effective amount may be continued to be applied to the developing roots after radicle emergence has taken place.

Embodiments may include a seed, plant, or portion of plant produced from exposure of the seed to any of the formulations described herein. One embodiment of the invention comprises a seed comprising an effective amount of MDHJ and/or other jasmonate, wherein the amount of MDHJ and/or other jasmonate is effective for improving a germination characteristic of the seed and is equivalent to that of a seed soaked in an MDHJ and/or other jasmonate concentration of about 1.5 mM or less in water for 24 hours. The seed may be a non-germinated seed and comprises a coating comprising MDHJ and/or another jasmonate. The improved germination characteristic may be a faster germination rate, a greater yield of mature plants from the seeds, or a longer average radicle length.

Embodiments may also include kits for pretreatment of a seed comprising MDHJ and/or another jasmonate in a liquid or solid formulation and a set of instructions for treating seeds with MDHJ in a manner that produces the same or about the same exposure to MDHJ or other jasmonate as a 24 hour soak in an MDHJ and/or other jasmonate solution in a liquid formulation of about 1.5 mM or less. The kits may further comprise seeds or soaking containers. In one embodiment the liquid is water. In embodiments, MDHJ and/or another jasmonate may be present in the liquid formulation at a concentration of 0.05 mM to 100 mM. In other embodiments, MDHJ and/or another jasmonate may be present in the liquid formulation in a concentration of up to 10 mM, 20 mM, 50 mM, or 100 mM, including 25 mM to 100 mM. In other embodiments, MDHJ and/or another jasmonate may be present in the liquid formulation at a concentration of 1.5 mM to 50 mM. In other embodiments, MDHJ and/or another jasmonate may be present in the liquid formulation at a concentration of 1.5 mM to 20 mM. In other embodiments, MDHJ and/or another jasmonate may be present in the liquid formulation at a concentration of 1.5 mM to 20 mM. In other embodiments, MDHJ and/or another jasmonate may be present in the liquid formulation at a concentration of 1.5 mM to 10 mM. In other embodiments, MDHJ and/or another jasmonate may be present in the liquid formulation at a concentration of 1.5 mM to 4.5 mM. In other embodiments, MDHJ and/or another jasmonate may be present in the liquid formulation at a concentration of 4.5 mM to 50 mM. In other embodiments, MDHJ and/or another jasmonate may be present in the liquid formulation at a concentration of 4.5 mM to 20 mM. In other embodiments, MDHJ and/or another jasmonate may be present in the liquid formulation at a concentration of 4.5 mM to 10 mM.

In addition to liquid preparations, MDHJ or other jasmonates may be formulated in solid formulations including slow-release or controlled-release applications such as a granular- or pellet-based form, including fertilizer and/or pesticide components. MDHJ or other jasmonates may be present in those formulations in weight/weight ratios of MDHJ or other jasmonates to other ingredients in the range of 0.001% to 1%. However, in some cases an effective ratio of MDHJ or other jasmonates could be greater than 1.0% or less than 0.001%. In other embodiments, MDHJ and/or other jasmonates are present at a concentration of 0.001% to 0.1%, 0.001% to 0.01%, 0.01% to 0.10%, 0.002% to 0.20%, 0.002% to 0.02%, 0.02% to 0.20%, 0.003% to 0.30%, 0.003% to 0.03%, 0.03% to 0.30%, 0.004% to 0.40%, 0.004% to 0.04%, 0.040% to 0.40%, 0.005% to 0.50%, 0.005% to 0.05%, 0.050% to 0.50%, 0.006% to 0.60%, 0.006% to 0.06%, 0.060% to 0.60%, 0.007% to 0.70%, 0.007% to 0.07%, 0.070% to 0.70%, 0.008% to 0.80%, 0.008% to 0.08%, 0.080% to 0.80%, and 0.009% to 0.90%, 0.009% to 0.09%, 0.090% to 0.90%. In other embodiments, MDHJ and/or other jasmonates are present at concentrations ranging from 1.0% to 2%, 2% to 3%, 3% to 4%, 4% to 5%, 5% to 6%, 6% to 7%, 7% to 8%, 8% to 9%, 9% to 10%, and 2% to 10%. Other inert or nutritive ingredients included in the pellets or granules can include binding agents and polymers, such as polysaccharides and polyvinylpyrrolidone, at 5-95%, a surfactant at 0.001-10%, and other absorptive ingredients, such as acrylamide and acrylamide polymers. The binding agents and other absorptive agents in the formulation may take up MDHJ or other jasmonates and release it at a steady state.

Embodiments of the invention may include formulations containing an amount of MDHJ effective for improving a germination characteristic of the seed or a stress tolerance characteristic of the seed. One embodiment comprises a liquid formulation comprising MDHJ and/or other jasmonates at a concentration of 1.5 mM or less, including 1.0 mM, 500 μM, 100 μM, 50 μM, 20 μM, 10 μM, 5 μM, 2 μM, and 1 μM. Another embodiment comprises a liquid formulation comprising MDHJ and/or other jasmonates at a concentration of 1.5 mM or greater, including 3 mM, 5 mM, 8 mM, 10 mM, 15 mM, 20 mM, 30 mM, 50 mM, 75 mM, and 100 mM. Another embodiment includes a solid formulation comprising a concentration that produced an exposure equivalent to a 24 hour soak in an MDHJ and/or other jasmonate solution of about 1.5 mM or less in water. The solid formulation may comprise MDHJ and/or other jasmonates at a concentration anywhere from 1.5 mM to 100 mM, including 1.5 mM to 50 mM, 1.5 mM to 20 mM, 1.5 mM to 10 mM, 1.5 mM to 4.5 mM, 4.5 mM to 50 mM, 4.5 mM to 20 mM, 4.5 mM to 10 mM, 10 mM to 40 mM, 10 mM to 30 mM, 10 mM to 25 mM, 25 mM to 75 mM, 25 mM to 50 mM, 25 mM to 40 mM, 25 mM to 100 mM, 40 mM to 80 mM, 40 mM to 60 mM, 40 mM to 50 mM, 50 mM to 100 mM, 50 mM to 80 mM, 50 mM to 75 mM, 50 mM to 60 mM, 60 mM to 90 mM, 60 mM to 80 mM, 60 mM to 70 mM, 70 mM to 90 mM, and 70 mM to 80 mM. In addition to MDHJ and/or other jasmonates, the liquid formulation and solid formulation may comprise any of the constituents described herein, including wetting agents, adjuvants, emulsifiers, dispersants, spreaders, stickers, pastes, anchorage agents, fixatives, extenders, coating agents, buffering agents, plant nutrients, absorptive additives, disintegrants, acids, bases, plant nutrients, plant growth regulators, plant defense activators, pesticides, insecticides, herbicides, fungicides, beneficial microbes or other active compounds.

For liquid formulations, water-based solvents may be used. An exemplary embodiment of a formulation of the invention is an aqueous solution containing 0.05 mM to 1.5 mM MDHJ and/or other jasmonate. The aqueous solution may further comprise a wetting agent and one or more constituents for modifying the pH of the solution. In an exemplary embodiment, the pH of the solution is acidic. However, other solvents may be used alternatively or in addition to water, including various organic solvents such as alcohols. Liquid formulations may include nonpolar organic solvents, polypropylenes, and vegetable or mineral oils. Solid formulations may be based on organic clays and include additional constituents such as binders including polysaccharides and polyvinylpyrrolidone, surfactants, and other absorptive ingredients, such as acrylamide and acrylamide polymers. The solid formulations may include those described in U.S. Patent Application Publication No. 2014/0066308, the disclosure of which is hereby incorporated by reference in its entirety.

Formulations including MDHJ and/or other jasmonates may be applied once or repeatedly, depending on the circumstances and the type of formulation, to treat a plant. For example, MDHJ and/or other jasmonate formulations according to embodiments of the invention may be applied to the seeds at varying exposure times. The MDHJ and/or other jasmonate formulations may be applied anywhere from 1 hour to 1 month of exposure. Exposure of seeds to liquid formulations of MDHJ and/or other jasmonates may include immersion or soaking in an MDHJ and/or other jasmonate solution or suspension, with optional agitation or stifling of the solution or suspension. Exposure of seeds to liquid formulations of MDHJ and/or other jasmonates may include continuous or repeated spraying of the solution on the seeds. Exposure of seeds to solid formulations of MDHJ and/or other jasmonates may include milling and mixing of seeds with the solid formulation. After exposure, the seeds may be removed from the formulations and optionally dried or rinsed to remove excess formulation from the seeds. The seeds may be dormant seeds, non-germinating seeds, or seeds in varying stages of germination. The seeds may be exposed at concentrations effective for improving germination characteristics or stress tolerance characteristics.

In other embodiments, alternatively or in addition to exposing seeds, formulations comprising MDHJ and/or other jasmonates may be applied to roots, foliage or some other part of a plant once or, alternatively, two or more times at defined intervals of time, such as every 2-14 days, every 30 days, or 1-2 times per month, in order to provide continued treatment for ameliorating stress symptoms. The intervals at which the MDHJ and/or other jasmonates are applied may vary. A plant may be treated with MDHJ and/or other jasmonates whether or not it is exhibiting symptoms of stress at the time of treatment. Additionally, plants may be treated with MDHJ and/or other jasmonates for purposes of reducing stress symptoms whether they are healthy or not. (For example, work by the present inventors has also shown that MDHJ is effective in reducing biotic attack and disease in plants; see, for example, U.S. Patent Application Publication No. 2009/0082453, the contents of which are incorporated by reference herein in their entirety. Therefore, a plant may be treated with MDHJ for multiple reasons.)

Among other factors, the environmental conditions around the plant or plants may influence the manner in which the MDHJ and/or other jasmonates is applied or its frequency. For example, if the seeds are field-grown or otherwise exposed to the elements, rain showers, excessive wind gusts, or other environmental factors shortly after an application, it may be desirable to reapply it. Under some circumstances, a more dilute formulation or solution may be used if repeated applications are to be performed.

Methods according to embodiments of the invention may include additional steps beyond the seed treatment itself. For example, the inventive methods may also comprise noting faster seed germination or a greater germination rate with the seeds that have been treated with MDHJ as compared with untreated seeds, or taking other actions based on the expectation of faster germination or greater germination rate. In some cases, a seed supplier may set a recommended harvest schedule, or other schedule or growing advice, based on the expectation of faster germination or greater germination rate in seeds that have been treated with MDHJ or other jasmonates. Methods according to embodiments of the invention may also involve planting fewer MDHJ-treated seeds than one would plant when using untreated seeds, with the expectation that the germination rate of MDHJ-treated seeds will be higher.

Methods according to embodiments of the invention may include application of MDHJ or other jasmonates before planting the seed. For example, MDHJ and/or other jasmonates may be dried down and applied to dormant seeds which would then be planted later, or applied as a seed soak with immediate planting afterward. In another approach, MDHJ and/or other jasmonates may be applied after planting with the first irrigation to dormant or just barely germinating seeds; or to germinating seedlings with subsequent irrigations (pre- or post-radicle emergence). In another embodiment, MDHJ and/or other jasmonates may be applied after planting along with herbicides, fertilizers, pesticides, etc., or could be applied at planting time along with other seed treatments. Solid preps of MDHJ and/or other jasmonates could also be applied at, before, or after planting.

The tasks of methods according to embodiments of the invention may be performed by different entities in some cases. In some embodiments, the end user or farmer may perform the seed treatment tasks just prior to, at the time of, or just after planting. For that reason, MDHJ and/or other jasmonate solutions suitable for use in seed treatment may be sold as concentrates that are diluted by the end user to the range of concentrations set forth here. In order to support ease of application by the end user, these solutions may be sold in kits with all necessary instructions and special equipment—e.g. a kit that includes a concentrated jasmonate or MDHJ solution or suspension (e.g., with MDHJ in a concentration of up to 10 mM, 20 mM, 50 mM, 100 mM or higher), printed instructions for diluting the concentrate and applying it to particular species or varietal of plant, and harvesting or other kinds of schedules. In some cases, instead of printed instructions, the kit may include indicia, like an Internet resource locator, link, or bar code that allows the end user to retrieve the appropriate instructions, or may include machine-readable media with the instructions encoded thereon. The kit may also include containers and applicators of appropriate sizes with appropriate graduations or other markings for mixing predefined volumes of jasmonate or MDHJ seed treatment solutions, or other liquid media, for treating seeds on a moderate to large scale. As those of skill in the art will understand, any other packaging or application elements that make it easier for an end user to perform an MDHJ seed treatment may be used or included.

In other embodiments, the seed treatment tasks themselves may be performed by seed manufacturers or wholesale suppliers, who then supply treated seed, typically through a network of distributors, to the end users. In those embodiments, the end user may need do nothing more than plant the seed and follow a set of growth or harvesting instructions or recommendations provided by the supplier. Embodiments of the invention include seeds treated according to methods of the invention. The seeds may include one or more coating agents for preserving the jasmonate or MDHJ content of the seeds, and may be packaged in airtight containers to prevent loss of jasmonate or MDHJ due to volatility.

It should be understood that embodiments of the invention encompass not only the methods described here, but also seeds, plants, and portions of plants that are produced by methods that include seed treatment with MDHJ and/or other jasmonates to improve germination or stress tolerance characteristics. As was noted briefly above, and as will be explained below in more detail, embodiments of the invention may also encompass situations in which MDHJ and/or other jasmonates is applied to seeds not to improve their germination characteristics per se but to obtain other jasmonate or MDHJ-mediated benefits later in the plant life cycle without compromising the germination characteristics of the seeds.

Embodiments of the invention may also include defense activating applications of MDHJ to improve one or more stress tolerance or other defense characteristics. Defense activation in the context of this specification can be mediated for example by molecules or compounds that activate plant defenses, such as by way of jasmonic acid dependent or independent pathways and/or by way of salicylic acid dependent or independent pathways. Such defense-activating applications can include treating developing seeds (or propagules) and/or plants, from which seeds (or propagules) and their progeny would then be more resistant to biotic and/or abiotic stress and lead to plants with greater productivity. Examples of defense activators that can be used according to embodiments of the invention are not limited to MDHJ but can include other jasmonates, such as methyl jasmonate, jasmonic acid, and/or derivatives of jasmonates; salicylic acid and derivatives; chitin; acibenzolar-S-methyl; harpins; and defense peptide, including combinations of the defense activators with MDHJ. Defense activators including defense peptides that may be used in embodiments of the invention include those described in U.S. application Ser. No. 14/454,374 which is hereby incorporated by reference herein in its entirety.

Examples of biotic stress factors which may be targeted for defense activating applications of MDHJ and/or other jasmonates and other defense activators of the invention include bacteria, viruses, fungi, parasites, insects, weeds, and other plants, as well as pests, such as herbivores. Examples of abiotic stress factors which may be targeted for defense activating applications of MDHJ and/or other jasmonates and other defense activators of the invention include drought, salt stress, osmotic stress, cold stress, heat stress, variations in temperature such as great or extreme variations in temperature, unseasonable temperature, mechanical (e.g. wind) stress, extreme wetness, nutrient deficiency, nutrient excess, radiation stress (e.g. ultraviolet), atmospheric pollution (e.g. ozone), and soil pollution (e.g. heavy metals, herbicides), soil quality, soil pH. The biotic or abiotic stresses may be any stress that involves the jasmonate/ethylene pathway or the salicylic acid pathway. It is important to note that the jasmonate/ethylene pathway or salicylic acid pathway may not always correlate with biotic or abiotic stress and that other pathways may alternatively or in addition be involved.

Further, defense activation of MDHJ and/or other defense activators of the invention may be assessed through a variety of measures. These measures may include but are not limited to better stand establishment, improved yield of plant product, increased seedling survival, increased biomass in early development, reduced wilting, reduced senescence, reduced stress symptoms, in plants treated with MDHJ and/or other defense activators in comparison to untreated plants. Such stress symptoms can include number of wilted plants, reduced size of the leaf area, lower plant height, lower plant weight, and earlier senescence.

Alternatively, a substantial defense activation activity is present where the defense activator, when applied to a plant exogenously or recombinantly expressed within a plant, confers a substantial change in any resistance to a biotic or an abiotic stress that modulates the jasmonate/ethylene or salicylic acid pathways, or any of the polypeptides described below. Polypeptides that the defense activators may modulate for improved stress tolerance under a variety of stress conditions can include but are not limited to polypeptides involved in gene regulation, such as serine/threonine-protein kinases, MAP kinases, MAP kinase kinases, and MAP kinase kinase kinases; polypeptides that act as receptors for signal transduction and regulation, such as receptor protein kinases; intracellular signaling proteins, such as protein phosphatases, GTP binding proteins, and phospholipid signaling proteins; polypeptides involved in arginine biosynthesis; polypeptides involved in ATP metabolism, including for example ATPase, adenylate transporters, and polypeptides involved in ATP synthesis and transport; polypeptides involved in glycine betaine, jasmonic acid, flavonoid or steroid biosynthesis. Enhanced or reduced activity of such polypeptides in transgenic plants in embodiments may provide changes in the ability of a plant to respond to a variety of stresses.

Embodiments of the invention may include methods in which MDHJ and/or other jasmonates are applied to a seed before, during, and/or after exposure to an environmental stress, such as the abiotic and biotic stresses discussed herein. Application of MDHJ and/or other jasmonates to the seed concurrent with such stresses may improve stress tolerance (biotic and abiotic), rate of development, yield, and reduced leaf senescence of established plants grown from treated seeds. The treated seeds may be non-germinated seeds, germinated seeds, or dormant seeds.

Embodiments of the invention also include seeds treated with MDHJ and/or other jasmonates. The seeds may be treated according to any of the methods described herein. The seed comprises an effective amount of MDHJ and/or another jasmonate, wherein the amount of MDHJ and/or another jasmonate is effective for improving a germination characteristic of the seed or improving a stress tolerance characteristic of the seed. In embodiments, the amount of MDHJ and/or other jasmonate is equivalent to a seed soaked in an MDHJ concentration of about 1.5 mM or less for 24 hours. The seeds of the invention may be non-germinated or dormant seeds. The seeds may be treated at a facility in bulk and then sold and distributed to third-party distributors and farmers. The seeds of the invention may include seeds for a variety of vegetables including soybean, wheat, corn, squash, peas, carrots, celery, tomatoes, lettuce, cabbage, eggplant, cauliflower, radishes, spinach, leeks, broccoli, eggplant, turnip, sweet potato, beans, yams, chilies, onion, garlic, cucumber, asparagus, avocado, black-eyed bean, broad bean, brussels sprouts, butternut squash, zucchini, endive, fennel, green bean, haricot bean, string bean, artichoke, leek, turnip, watercress, bell peppers, chard, okra, parsnips, kale, pumpkin, horseradish, ginger, tomatoes, rhubarb, parsnips, shallots, rutabagas, watercress, arugula, kohlrabi, jicama and the like. In the embodiment, the seeds may also be considered “pre-treated” as no additional treatment is required on the part of the consumer. The seeds may be further coated with a thin protective layer such as shellac or other resin to prevent loss of MDHJ from volatility. The seeds may be sold as packaged varieties to farmers and the gardening public that are ready for planting. The seeds may be packaged in air-tight sealed containers to prevent loss of MDHJ from volatility.

Aspects of the invention will be described below in more detail with respect to the following examples. Unless otherwise noted, in the following examples, the MDHJ was obtained from Bedoukian Research, Inc. (Danbury, Conn., United States; product no. 398E). As supplied, the MDHJ solution was specified as having a minimum purity of 92.5%, of which 25-40% was the “epi” or “cis” isomer of MDHJ, shown as Formula (4) below:

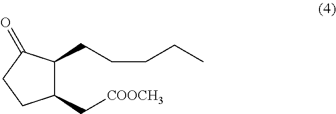 [SMILES: CCCCC[C@@H]1C(=O)CC[C@@H]1CC(=O)OC]

### EXAMPLES

### Examples 1-4

### Experiments

### Example 1

### Treatment of Corn Seeds with MDHJ Soak Solutions in Water

Non-germinated seeds of the corn varietal ‘Kandy Korn’ are soaked in one of three treatment solutions for 24 hours in 50 mL conical vessels. During the soak, the seeds spent 12 hours in typical lighting conditions and 12 hours in darkness. The three treatment solutions are set forth below in Table 1.

TABLE 1
Treatment Solutions for Example 1.

| Identifier | Treatment Solution |
|---|---|
| UTC | Water (untreated control group) |
| JAZ-1 | 1.5 mM MDHJ in water |
| JAZ-2 | 4.5 mM MDHJ in water |

Following seed treatment, the treatment solutions are drained from their vessels and a selection of seeds are taken from each vessel for planting. Six two-inch pots are planted for each treatment group, with three seeds per pot, for a total of 18 seeds planted per treatment. The unplanted seeds are allowed to remain in their original vessels in lighted conditions.

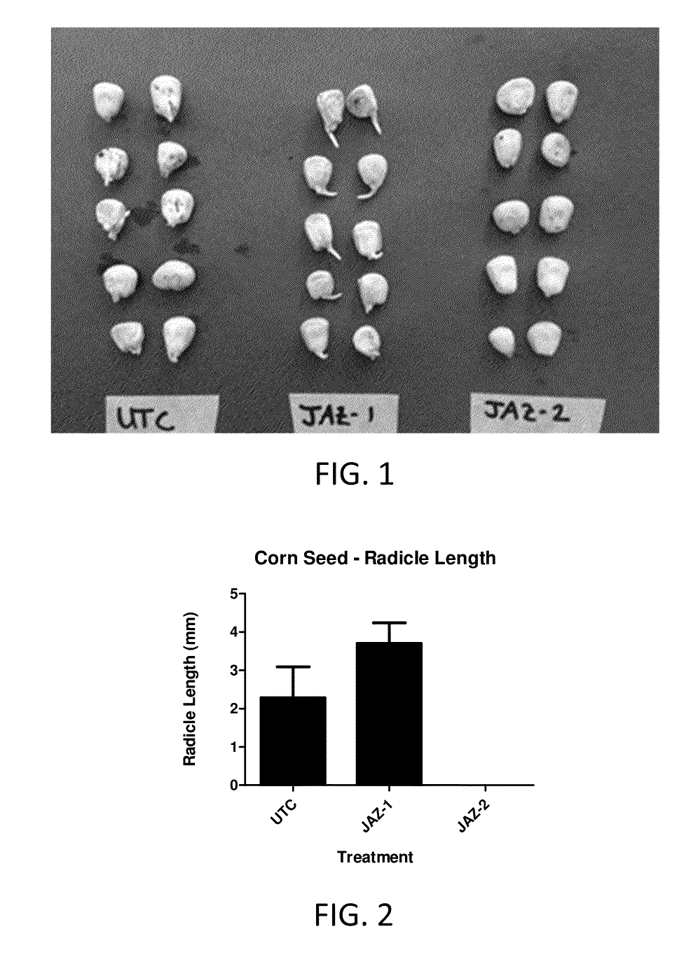

At day four after planting, the germination rate was examined for ten treated, unplanted seeds selected at random from each of the original vessels. The germination rate (percent of seeds that germinated) in each group is set forth in Table 2 below. In addition to determining the germination rate, the radicle lengths of the germinated seeds are measured. The chosen representative seeds for each group are shown in the photograph of FIG. 1. FIG. 2 is a bar graph illustrating average radicle length in the seeds of FIG. 1. As is shown in FIG. 2, average radicle length was significantly longer in the JAZ-1 group as compared with the untreated control. Table 3 below includes the radicle length measurements for each group.

TABLE 2
Germination Rate in Each Treatment Group.

| Identifier | Germination Rate (n = 10) |
|---|---|
| UTC | 70% |
| JAZ-1 | 100% |
| JAZ-2 | 0% |

TABLE 3
Radicle Length Measurements (millimeters) of Unplanted,
Germinated Seeds in Each Treatment Group

| UTC | JAZ-1 | JAZ-2 |
|---|---|---|
| 1 | 6 | 0 |
| 2 | 5 | 0 |
| 7 | 4 | 0 |
| 2 | 6 | 0 |
| 1 | 4 | 0 |
| 2 | 3 | 0 |
| 1 | 4 | 0 |
| | 2 | 0 |
| | 2 | 0 |
| | 1 | 0 |

At days 8 and 14 after planting, the number of seedlings that emerged from each group of potted plants was counted, and is shown in Table 4 below.

TABLE 4
Number of Emerged Seedlings.

| Group | Day 8 | Day 14 |
|---|---|---|
| UTC | 1 | 15 |
| JAZ-1 | 6 | 14 |
| JAZ-2 | 1 | 10 |

The results of Example 1 demonstrate that the seeds in the JAZ-1 group, exposed to 1.5 mM MDHJ, emerged faster than the untreated control. The results also demonstrate that the treated seeds had a longer average radicle length than in the untreated control. The JAZ-2 group, exposed to higher-concentration 4.5 mM MDHJ appeared to exhibit some inhibition of germination.

### Example 2

### Treatment of Corn Seeds with MDHJ Soak Solutions with Wetting Agent

Non-germinated seeds of the hybrid corn varietal “Early Sun Glow” were treated with MDHJ by soaking for 24 hours in 50 mL conical vessels in one of four treatment solutions. During the soak, the seeds spent 12 hours in typical lighting conditions and 12 hours in darkness. The four treatment solutions are set forth below in Table 5. In Table 5, COCO-WET® is a wetting agent sold by Spray-N-Grow, Inc. of Rockport, Tex.

TABLE 5
Treatment Solutions for Example 2.

| Identifier | Treatment Solution |
|---|---|
| A | Water + .025 ml/L COCO-WET ® + 0.134 g/L citric |
| | acid (pH 4.5) (control group) |
| B | 0.15 mM MDHJ + 0.025 ml/L COCO-WET ® + 0.134 g/L |
| | citric acid (pH 4.5) |
| C | 1.50 mM MDHJ + 0.025 ml/L COCO-WET ® + 0.134 g/L |
| | citric acid (pH 4.5) |
| D | 4.50 mM MDHJ + 0.025 ml/L COCO-WET ® + 0.134 g/L |
| | citric acid (pH 4.5) |

On Day 2, 4 2-inch pots were planted with three seeds each, for a total of 12 seeds per treatment. Germination of the potted seeds was measured at days 8 and 15. The results are shown below in Table 6.

TABLE 6
Germination of Plants in Example 2.

# Seeds
Germinated

| Identifier | Day 8 | Day 15 |
|---|---|---|
| A | 5 | 6 |
| B | 9 | 10 |
| C | 6 | 6 |
| D | 1 | 1 |

### Example 3

### Sugar Snap Pea Seeds Treated with MDHJ Soak Solutions with Wetting Agent

Sugar snap pea seeds were treated according to the procedure in Example 2. The number of seeds germinated were counted at days 8 and 15 after treatment. The results are in Table 7 below.

TABLE 7
Germination of Plants in Example 3.

# Seeds
Germinated

| Identifier | Day 8 | Day 15 |
|---|---|---|
| A | 3 | 5 |
| B | 3 | 4 |
| C | 1 | 1 |
| D | 0 | 0 |

### Example 4

### Redina Lettuce Seeds Treated with MDHJ Soak Solutions with Wetting Agent

Seeds of Redina lettuce (Lechuga redina) were treated with MDHJ according to the protocol of Example 2. At 15 days after treatment, no adverse effects on germination were seen in seeds treated with MDHJ at concentrations below 1.5 mM.

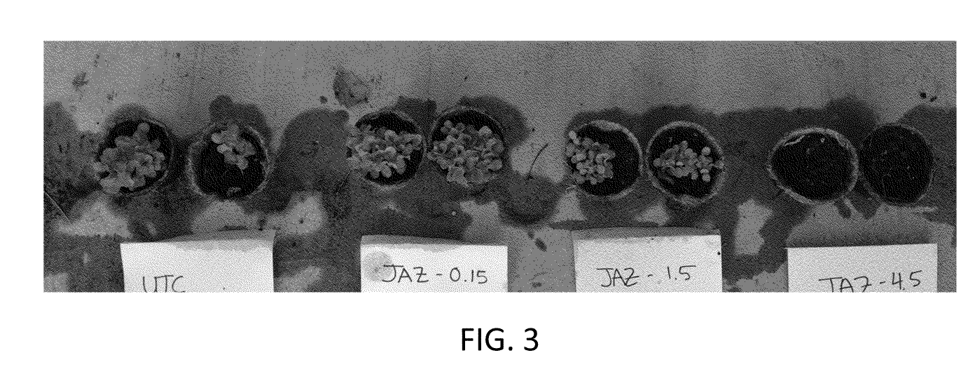

FIG. 3 is a photograph of the potted lettuce plants taken at day 15.

As Examples 3 and 4 demonstrate, even in peas and lettuce, where no germination benefit was seen from MDHJ exposure, MDHJ concentrations under 1.5 mM were surprisingly found not to adversely affect germination.

### Examples 5-11

### Example 5

### Seed Germination at Low Concentrations of MDHJ

Non-germinated seeds of a commercial corn variety are soaked in a treatment solution or water for up to 24 hours in 50 mL conical vessels. During the soak, the seeds can spend up to 12 hours in typical lighting conditions and up to 12 hours in darkness, or up to 24 hours of light, or up to 24 hours of dark. Treatment solutions are set forth below in Table 8.

TABLE 8
Treatment Groups According to MDHJ Concentration

| Identifier | MDHJ [ ] |
|---|---|
| A | 0 |
| B | 0.05 mM |
| C | 0.10 mM |
| D | 0.25 mM |
| E | 0.50 mM |
| F | 1.0 mM |
| G | 1.5 mM |

Following the seed treatment, the treatment solutions are drained from their respective vessels (and optionally dried) and a selection of seeds are taken from each vessel for planting. At a selected point after planting (such as day four), the germination rate is examined. It is expected that the results would show a dose dependent increase in germination rate in the treatment groups B-G and a significant increase in radicle length in groups E, F, and G in comparison to group A.

### Example 6

### Cold Stress

Non-germinated seeds of a commercial corn variety are divided into four treatment groups. Seeds are exposed to two treatments (temperature and MDHJ concentration) in a 2×2 factorial design as shown in Table 9. Seeds are exposed to MDHJ or distilled water for up to 24 hours. During the soak, the seeds can be exposed to up to 12 hours of typical lighting conditions and up to 12 hours in darkness. The seeds are then transferred to soil (after optionally drying the seeds) at cold or room temperature.

TABLE 9
Treatment Groups According to Temperature
And MDHJ Concentration

| Identifier | Temperature | MDHJ [ ] |
|---|---|---|
| A | 22° C. | 0 |
| B | 5° C. | 0 |
| C | 22° C. | 1.5 mM |
| D | 5° C. | 1.5 mM |

The number of seeds germinated at days 8 and 15 are then measured. The results are expected to show a significantly reduced number of seeds germinated in group B in comparison to group A at days 8 and 15, while the number of seeds germinated in group D is expected to be comparable to group A at these times. The results are also expected to show that the number of seeds germinated in group C is significantly greater than group A at day 8. Similar results are expected to be obtained when radicle length is measured.

The plants in each group are allowed to grow for 30 days at the respective temperatures, at which time yield was measured. The results are expected to show a significantly reduced yield of plants in group B in comparison to group A at 30 days, while yields of plants in group D are expected to be comparable to that of group B.

### Example 7

### Heat Stress

Non-germinated seeds of a commercial corn variety are divided into four treatment groups. Seeds are exposed to two treatments (temperature and MDHJ concentration) in a 2×2 factorial design as shown in Table 10. Seeds are exposed to MDHJ or distilled water for up to 24 hours and then transferred to soil and kept at hot or room temperature. During the soak, the seeds can spend up to 12 hours in typical lighting conditions and up to 12 hours in darkness, or up to 24 hours in darkness or up to 24 hours in light.

TABLE 10
Treatment Groups According to Temperature and MDHJ Concentration

| Identifier | Temperature | MDHJ [ ] |
|---|---|---|
| A | 22° C. | 0 |
| B | 40° C. | 0 |
| C | 22° C. | 1.5 mM |
| D | 40° C. | 1.5 mM |

The number of seeds germinated at days 8 and 15 are then measured. The results are expected to show a significantly reduced number of seeds germinated in group B in comparison to group A at days 8 and 15, while the number of seeds germinated in group D is expected to be comparable to group A at these times. The results are also expected to show the number of seeds germinated in group C is significantly greater than group A at day 8. Similar results should be obtained when radicle length is measured.

The plants in each group are allowed to grow for 30 days at the respective temperatures, at which time yield is measured. The results are expected to show a significantly reduced yield of plants in group B in comparison to group A at 30 days, while yields of plants in group D are expected to be comparable to that of group B.

### Example 8

### Drought Stress

Non-germinated seeds of a commercial corn variety are divided into six treatment groups in a 3×2 factorial design.

Seeds are exposed to MDHJ or distilled water for up to 24 hours and then transferred to soil and kept at room temperature for 7 days. The plants are provided water daily (“Water”), every other day (“Partial Drought”) or only on day 1 (“Drought”). The design of the experiment is shown in Table 11 below.

TABLE 11
Treatment Groups According to Watering Conditions
and MDHJ Concentration

| Identifier | Watering Conditions | MDHJ [ ] |
|---|---|---|
| A | Water | 0 |
| B | Partial Drought | 0 |
| C | Drought | 0 |
| D | Water | 1.5 mM |
| E | Partial Drought | 1.5 mM |
| F | Drought | 1.5 mM |

The number of seeds germinated at days 8 and 15 are then measured. The results are expected to show a significantly reduced number of seeds germinated in group C in comparison to groups A and B at day and 15. The results are also expected to show a greater number of seeds germinated in group F compared to group C such that no significant difference is observed in the number of seeds germinated between group F and group D. Similar results are expected to be obtained when radicle length is measured.

The plants in each group are allowed to grow for 60 days at the respective watering conditions, at which time leaf senescence is measured as quantified by chlorosis and necrosis. The results are expected to show significantly increased leaf senescence in group C in comparison to groups A and B at day 60. The results are also expected to show improvement in leaf senescence in group F compared to group C such that no significant difference is observed in leaf senescence between group F and group D.

### Example 9

### Soil pH Stress

Non-germinated seeds of a commercial corn variety are divided into six treatment groups in a 3×2 factorial design.

Seeds are exposed to MDHJ or distilled water for up to 24 hours and then transferred to soil in individual pots and kept at room temperature for 7 days. The plants are divided into three soil pH treatments of 6.5, 9, and 12 as shown in Table 12 below.

TABLE 12
Treatment Groups According to Soil pH and MDHJ Concentration

| Identifier | Soil pH | MDHJ [ ] |
|---|---|---|
| A | 6.5 | 0 |
| B | 9 | 0 |
| C | 12 | 0 |
| D | 6.5 | 1.5 mM |
| E | 3 | 1.5 mM |
| F | 12 | 1.5 mM |

The number of seeds germinated at days 8 and 15 are then measured. The results are expected to show a significantly reduced number of seeds germinated in groups B and C in comparison to group A at day and 15. The results are also expected to show a greater number of seeds germinated in groups E and F and compared to groups B and C such that no significant difference is observed in the number of seeds germinated between groups E and F and group D. Similar results are expected to be obtained when radicle length is measured.

The plants in each group are allowed to grow for 60 days at the respective watering conditions, at which time yield is measured. The results are expected to show significantly decreased yield in group C in comparison to groups A and B at day 60. The results are also expected to show improvement in yield in group F compared to group C such that no significant difference is observed in yield between group F and group D.

### Example 10

### Heavy Metal Stress

Non-germinated seeds of a commercial corn variety are divided into six treatment groups in a 3×2 factorial design.

Seeds are exposed to MDHJ or distilled water for up to 24 hours and then transferred to soil and kept at room temperature for 7 days. Half the plants are exposed to 100 ppm CdCl₂ and half are not as shown in Table 13 below.

TABLE 13
Treatment Groups According to CdCl₂ and MDHJ Concentrations

| Identifier | CdCl₂ [ ] | MDHJ [ ] |
|---|---|---|
| A | 0 | 0 |
| B | 100 ppm | 0 |
| C | 0 | 0.50 mM |
| D | 100 ppm | 0.50 mM |
| E | 0 | 1.5 mM |
| F | 100 ppm | 1.5 mM |

The number of seeds germinated at days 8 and 15 are then measured. The results are expected to show a significantly reduced number of seeds germinated in group B in comparison to groups A at day 15. The results are also expected to show a greater number of seeds germinated in groups D and F compared to group B such that no significant difference is observed in the number of seeds germinated between groups C and D and groups E and F. Similar results are expected to be obtained when radicle length is measured.

The plants in each group are allowed to grow for 45 days at the respective CdCl₂ exposures, at which time leaf browning is measured. The results are expected to show a significantly increased browning in group B in comparison to groups A at day 45. The results are also expected to show decreased browning in groups D and F compared to group B such that no significant difference is observed in the extent of browning between groups C and D and groups E and F.

### Example 11

### Salt Stress

Non-germinated seeds of a commercial corn variety are divided into six treatment groups in a 3×2 factorial design.

Seeds are exposed to MDHJ or distilled water for up to 24 hours and then transferred to soil in individual pots and kept at room temperature. Half the plants are exposed to 1000 ppm NaCl and half are not exposed, as shown in Table 14 below.

TABLE 14
Treatment Groups According to NaCl Concentration
and MDHJ Concentration

| Identifier | NaCl [ ] | MDHJ [ ] |
|---|---|---|
| A | 0 | 0 |
| B | 1000 ppm | 0 |
| C | 0 | 0.50 mM |
| D | 1000 ppm | 0.50 mM |
| E | 0 | 1.5 mM |
| F | 1000 ppm | 1.5 mM |

The number of seeds germinated at days 8 and 15 are then measured. The results are expected to show a significantly reduced number of seeds germinated in group B in comparison to groups A at days 8 and 15. The results are also expected to show a greater number of seeds germinated in groups D and F compared to group B such that no significant difference is observed in the number of seeds germinated between groups C and D and groups E and F at days 8 and 15. Similar results are expected when radicle length is measured.

Plants in each group are allowed to grow for 90 days at the respective NaCl exposures, at which time leaf wilting is measured. The results are expected to show increased wilting in group B in comparison to groups A at day 90. The results also are expected to show decreased wilting in groups D and F compared to group B such that no significant difference is observed in the extent of wilting between groups C and D and groups E and F.

### Example 12

### Water Stress

Non-germinated seeds of a commercial corn variety are divided into four treatment groups. Seeds are exposed to MDHJ or distilled water for up to 24 hours and then transferred to soil and kept at room temperature for 7 days. The plants are then provided Adequate Water or Excessive Water (i.e. drowning the roots). The design of the experiment is shown in Table 15 below.

TABLE 15
Water Stress Treatment Groups

| Identifier | Watering Conditions | MDHJ [ ] |
|---|---|---|
| A | Adequate Water | 0 |
| B | Excessive Water | 0 |
| C | Adequate Water | 1.5 mM |
| D | Excessive Water | 1.5 mM |

The number of seeds germinated at days 8 and 15 are then measured. The results are expected to show a significantly reduced number of seeds germinated in group B in comparison to group A at day 8 and 15. The results are also expected to show a greater number of seeds germinated in group D compared to group B such that no significant difference is observed in the number of seeds germinated between group D and group C. Similar results are expected to be obtained when radicle length is measured.

The plants in each group are allowed to grow for 60 days at the respective watering conditions, at which time leaf senescence is measured as quantified by chlorosis and necrosis. The results are expected to show significantly increased leaf senescence in group B in comparison to groups A at day 60. The results are also expected to show improvement in leaf senescence in group D compared to group B such that no significant difference is observed in leaf senescence between group C and group D.

### Examples 13-25

### Compositions and Methods

### Example 13

An exemplary embodiment of a composition according to the invention comprises a stock solution of MDHJ at a concentration of 1 M in water.

### Example 14

An exemplary embodiment of a composition according to the invention comprises a soak solution of MDHJ at a concentration of 100 mM in water.

### Example 15

An exemplary embodiment of a composition according to the invention comprises a soak solution of MDHJ at a concentration of 1.5 mM in water.

### Example 16

An exemplary embodiment of a composition according to the invention comprises an aqueous solution of MDHJ comprising the following components:

0.5 mM MDHJ

0.1% v/v TRITON® X-100

Distilled Water

### Example 17

An exemplary embodiment of a composition according to the invention comprises an emulsion comprising the following components:

10 mM MDHJ

50% v/v canola oil

50% v/v water

### Example 18

An exemplary embodiment of a composition according to the invention comprises an aqueous soak solution comprising MDHJ at a concentration of 1.0 mM and the non-ionic surfactant alkylphenol ethoxylate at a concentration of 0.2% v/v.

### Example 19

An exemplary embodiment of a composition according to the invention comprises a solid preparation obtained by milling and mixing the following ingredients: MDHJ in a weight/weight ratio of about 0.8%, polyvinylpyrrolidone at a weight/weight ratio of 20%, and talc at a weight/weight ratio of 10% in 70 g kaolin clay.

### Example 20

An exemplary embodiment of a composition according to the invention comprises a solid preparation obtained by milling and mixing the following ingredients: MDHJ in a weight/weight ratio of about 0.5%, starch at a weight/weight ratio of 10%, and talc at a weight/weight ratio of 10% in 80 g bentonite clay.

### Example 21

An exemplary embodiment of a composition according to the invention comprises a solid preparation obtained by milling and mixing the following ingredients: MDHJ in a weight/weight ratio of about 1.0%, cellulose at a weight/weight ratio of about 15%, Triton-X at a weight/weight ratio of about 0.01%, acrylamide at a weight/weight ratio of about 5%, talc at a weight/weight ratio of about 10% in 70 g kaolin clay.

### Example 22

An exemplary embodiment of a composition according to the invention comprises a solid preparation obtained by milling and mixing the following ingredients: MDHJ in a weight/weight ratio of about 2.0%, 3 g of calcium lignin sulfonate, 2 g of sodium lauryl sulfate and 73 g of synthetic hydrated silicon oxide.

### Example 23

An exemplary embodiment of a method according to the invention comprises application of a solution or emulsion of any of Examples 13 to 17 to seeds of Zea mays commercial variety. The seeds are soaked in the solution or emulsion of any of Examples 13 to 17 for 24 hours prior to planting in soil.

### Example 24

An exemplary embodiment of a method according to the invention comprises application of a solid preparation of any of Examples 18 to 21 to seeds of Zea mays commercial variety. The seeds are coated with the solid preparation of any of Examples 18 to 21 prior to planting in soil.

### Example 25

An exemplary embodiment of a method according to the invention comprises exposure of leaves of 4 week old Zea mays plants to a volatile MDHJ solution for 7 days and subjecting them to various stress conditions. After seven days, the plants are evaluated for stress tolerance characteristics.

### Example 26

Seeds of tomato (‘Crimson Carmello’) were soaked in water for 24 hours. After 24 hours, seeds were transferred to a solution containing water only (untreated control or UTC), 0.05 mM MDHJ, or 0.5 mM MDHJ in water. There were 8-9 seeds per treatment. After soaking for 1 hour, the seeds were rinsed in water and placed between two layers of water-moistened paper towel in a clear plastic covered tray. The trays were placed at room temperature with normal daylight conditions and allowed to germinate. At day 5 and 7, the percent of germinated seeds was obtained. At days 5 and 7, radicle length was measured in tomato seedlings (no coleoptiles were showing yet).

TABLE 16
Percent Germination of Tomato Seeds Treated at Germinating Stage

Percent of Tomato
Seeds Germinated

| MDHJ Concentration (mM) | Day 5 | Day 7 |
|---|---|---|
| 0.00 (UTC) | 87.5 | 100 |
| 0.05 | 87.5 | 100 |
| 0.50 | 100 | 100 |

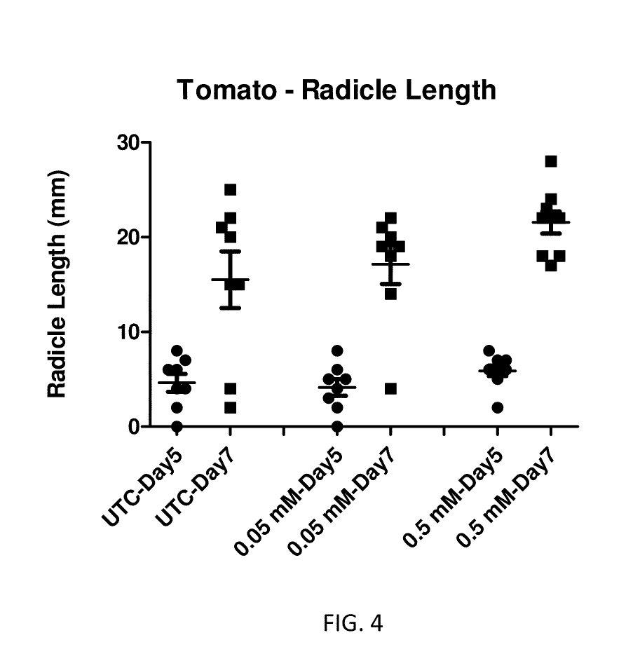

At Day 5 and 7, radicle length was measured in millimeters. As shown in FIG. 4, results show that treating germinating seed with 0.5 mM MDHJ results in an increase in radicle length compared to untreated seeds by day 7. Seed germination percentage was also enhanced.

### Example 27

Seeds of wheat (Triticum aestivum ‘Liquid Sunshine’) were soaked in water for 24 hours. After 24 hours, seeds were transferred to a solution containing water only (untreated control or UTC), 0.05 mM MDHJ, 0.5 mM MDHJ, or 5.0 mM MDHJ in water. There were 16-20 seeds per treatment. After soaking for 1 hour, the seeds were rinsed in water and placed between two layers of water-moistened paper towel in a clear plastic covered tray. The trays were placed at room temperature with normal daylight conditions and allowed to germinate. At day 7, the percent of germinated seeds was obtained and coleoptile length was measured.

TABLE 17
Percent Germination of Wheat Seeds Treated at Germinating Stage

| MDHJ Concentration | Percent of Wheat Seeds |
|---|---|
| (mM) | Germinated at Day 7 |
| 0.00 (UTC) | 88 |
| 0.05 | 95 |
| 0.50 | 53 |
| 5.00 | 55 |

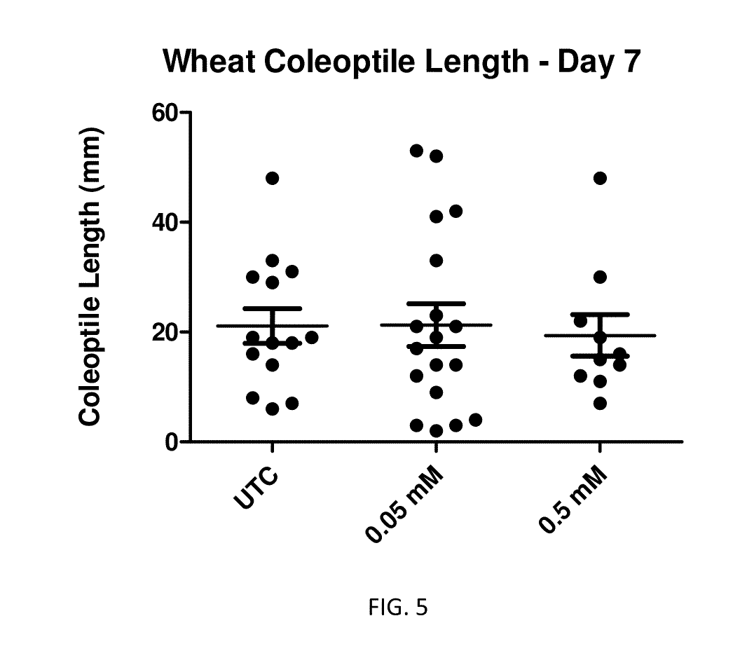

Results show an increased seed germination percentage at 0.05 mM MDHJ treatment compared to the untreated control (UTC). Germination inhibition did not occur until treatment of the germinating seed at 0.5 mM and above. As shown in FIG. 5, in the case of wheat, germination was improved at 0.05 mM MDHJ and there was no decrease in coleoptile length, while at 0.5 mM and above, there was inhibition of germination and coleoptile growth, and the 5.0 mM treatment, though germinated, had coleoptiles and radicles too short to measure.

### Example 28

Seeds of wheat (Triticum aestivum ‘Liquid Sunshine’), corn (‘Sugar Pearl’) and swiss chard (‘Peppermint Stick’) were soaked in water for 48 hours, immediately followed by a 1 hour soak in no MDHJ (untreated control, or UTC), 1.5 mM MDHJ or 7.5 mM MDHJ. Seeds were then rinsed and placed between sheets of moistened paper towel and surrounded by a saran wrap tent to keep the germinating environment moist. There were 13-25 seeds for each treatment of each plant. At Day 6, seed germination was measured for each plant.

TABLE 18
Percent Germination of Wheat, Corn, and Swiss Chard Seeds
Treated at Germinating Stage

| MDHJ Concentration | Percent of Seeds Germinated at Day 6 | | |
|---|---|---|---|
| (mM) | Swiss Chard | Corn | Wheat |
| 0.0 (UTC) | 69 | 50 | 100 |
| 1.5 | 77 | 54 | 100 |
| 7.5 | 58 | 0.1 | 100 |
| General Observation | Radicle size is | Similar size radicle | 1.5 mM and 7.5 mM |
| | uniform between all | and coleoptile | MDHJ treated seeds |
| | treatments. No visual | between treatments. | appear stunted in |
| | signs of growth | No visual signs of | coleoptile and radicle |
| | inhibition with MDHJ | growth inhibition with | size compared to UTC |
| | treatment. | MDHJ treatment at | (no MDHJ). |
| | | 1.5 mM. | |

Results show that germination is improved in swiss chard and corn by treating germinating seeds with 1.5 mM MDHJ. Wheat seeds germinated but seedlings were stunted in the 1.5 mM and 7.5 mM MDHJ-treated treatments. When taking into account the results from Examples 26 and Example 27, it appears that concentrations below 0.5 mM are beneficial for improved rate of seed germination in wheat under conditions of germinating wheat in paper towel with the described treatment method.

### Example 29

Seeds of corn (‘Sugar Pearl’) were soaked in water for 48 hours and subsequently planted 1-inch deep in potting soil in 6-inch pots. Two days after planting, the soil was sprayed with 12.5 ml/pot of 0 mM (UTC), 0.75 mM or 7.5 mM MDHJ. There were 8 seeds planted per pot and two pots for each treatment (n=16). Germination was recorded 21 days after planting, and plant height measured 24 days after planting.

TABLE 19
Percent Germination of Corn Seeds Treated at Germinating Stage

| Concentration of MDHJ (mM) | Percent Seedling Emergence |
|---|---|
| 0.00 (UTC) | 50 |
| 0.75 | 63 |
| 7.50 | 50 |

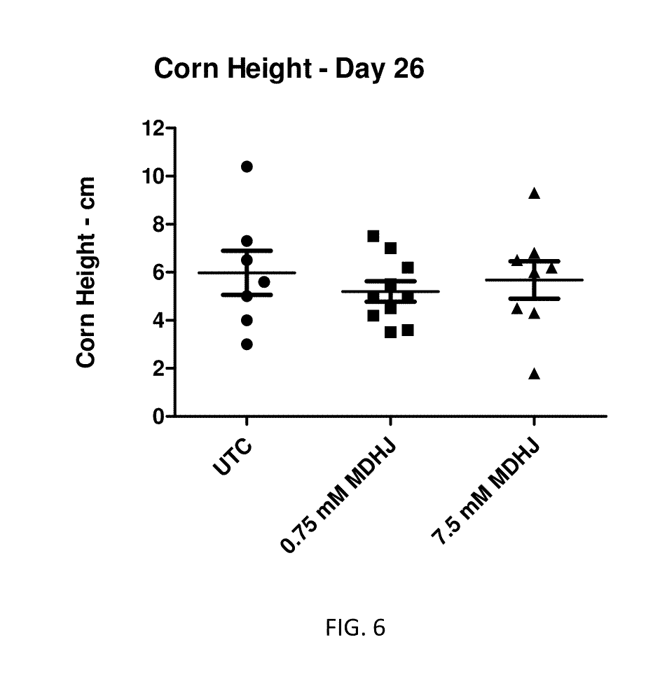

Results show increased germination in 0.75 mM-treated seed and no germination inhibition at 7.5 mM treated seed compared to the untreated control. As shown in FIG. 6, MDHJ treatment also did not inhibit growth.

The present invention has been described with reference to particular embodiments having various features. In light of the disclosure provided above, it will be apparent to those skilled in the art that various modifications and variations can be made in the practice of the present invention without departing from the scope or spirit of the invention. One skilled in the art will recognize that the disclosed features may be used singularly, in any combination, or omitted based on the requirements and specifications of a given application or design. When an embodiment refers to “comprising” certain features, it is to be understood that the embodiments can alternatively “consist of” or “consist essentially of” any one or more of the features. Other embodiments of the invention will be apparent to those skilled in the art from consideration of the specification and practice of the invention.

It is noted in particular that where a range of values is provided in this specification, each value between the upper and lower limits of that range is also specifically disclosed. The upper and lower limits of these smaller ranges may independently be included or excluded in the range as well. The singular forms “a,” “an,” and “the” include plural referents unless the context clearly dictates otherwise. It is intended that the specification and examples be considered as exemplary in nature and that variations that do not depart from the essence of the invention fall within the scope of the invention. Further, all of the references cited in this disclosure are each individually incorporated by reference herein in their entireties and as such are intended to provide an efficient way of supplementing the enabling disclosure of this invention as well as provide background detailing the level of ordinary skill in the art.

1. A method of seed treatment comprising exposing a seed to methyl dihydrojasmonate (MDHJ) at an amount and duration effective for improving a germination characteristic of the seed or at an amount and duration effective for improving a stress tolerance characteristic of a seedling or plant resulting from the seed.

2. The method of claim 1, wherein the MDHJ is present in a liquid or solid formulation.

3. The method of claim 2, wherein the MDHJ is present in the liquid formulation at a concentration of 0.05 mM to 100 mM.

4. The method of claim 3, wherein the MDHJ is present in the liquid formulation at a concentration of 1.5 mM to 20 mM.

5. The method of claim 4, wherein the MDHJ is present in the liquid formulation at a concentration of 4.5 mM to 10 mM.

6. The method of claim 2, wherein the MDHJ is present in the liquid formulation at a concentration of 0.15 mM to 4.5 mM.

7. The method of claim 2, wherein the MDHJ is present in the solid formulation at a concentration of 0.001% to 1.0% by weight.

8. The method of claim 1, wherein exposing the seed to the MDHJ produces an exposure of the seed that is at least equivalent to a 24 hour soak in a 1.5 mM solution of MDHJ in water.

9. The method of claim 1, wherein the MDHJ is present in an aqueous solution containing 0.05 mM to 1.5 mM MDHJ.

10. The method of claim 1, further comprising providing the seed, wherein the seed is at a stage in development that is prior to radicle emergence.

11. The method of claim 1, further comprising providing the seed, wherein the seed is at a stage in development that is after radicle emergence.

12. The method of claim 1, wherein the germination characteristic of the seed is germination rate, rate of development, vigor, or yield of mature plants originating from the seed.

13. The method of claim 1, wherein the exposing of the seed to the MDHJ comprises planting the seed in soil and applying the MDHJ to the soil.

14. The method of claim 1, wherein the improvement of a stress tolerance characteristic comprises increased yield, increased growth rate, decreased browning, decreased wilting, and/or decreased leaf senescence.

15. The method of claim 1, wherein the stress tolerance characteristic is resistance to an abiotic stress selected from the group consisting of drought, salt stress, osmotic stress, cold stress, heat stress, temperature stress, mechanical stress, stress from wetness, nutrient deficiency, nutrient excess, radiation stress, atmospheric pollution, soil pollution, soil quality, and soil pH.

16. The method of claim 1, wherein the stress tolerance characteristic is resistance to a biotic stress selected from the group consisting of bacteria, viruses, fungi, parasites, insects, weeds, other plants, and herbivores.

17. A seed comprising an amount of MDHJ effective for improving a germination characteristic or a stress tolerance characteristic of a seedling or plant resulting from the seed.

18. The seed of claim 17, wherein the amount of MDHJ produces an exposure equivalent of the seed that is at least equivalent to a seed soak in an aqueous solution of MDHJ at a concentration of up to 1.5 mM for 24 hours.
